(19) United States
(12) Patent Application Publication
(10) Pub. No.: US 2013/0054431 A1
(43) Pub. Date: Feb. 28, 2013

(54) System and Method for Integrated Use of Shared Hardware, Software and Storage Resources Communicating Through a Network to Standardize and Simplify Transactions Between an Organization and Entities That Do Business With The Organization

(71) Applicant: Mark A. Forman, Bethesda, MD (US)

(72) Inventor: Mark A. Forman, Bethesda, MD (US)

(73) Assignee: GOVERNMENT TRANSACTION SERVICES, INC., Vienna, VA (US)

(21) Appl. No.: 13/593,641

(22) Filed: Aug. 24, 2012

Related U.S. Application Data
(60) Provisional application No. 61/527,319, filed on Aug. 25, 2011.

(51) Int. Cl. G06Q 50/26; G06Q 40/00

(52) U.S. Cl. 705/30; 705/35

(57) ABSTRACT

Systems and methods that use “cloud” technologies to standardize and simplify transactions between the Federal government and entities that do business with it. The system may include cloud storage containing data files for account user data, grant reporting documentation and grant results/products; secure storage for user account/e-commerce data and USASPENDING archival data on the grant; and regulatory decision support tools for use among administrators, principal investigators, and program directors. The system may include a grant decision support engine for optimizing use of grant funds and a regulatory assistance engine for grant regulatory compliance, reporting, and approval requirements specific to Federal agencies.

### CLAIM TO PRIORITY

This application claims the benefit of U.S. Provisional Patent Application No. 61/527,319, filed Aug. 25, 2011, which is herein incorporated by reference in its entirety.

### FIELD OF THE INVENTION

The invention includes artificial intelligence software and databases that aid in interpreting regulatory requirements and formulating compliance decisions regarding Federal regulation requirements, terminology, restrictions, definitions, and principles (such as the Allowable Cost Principles). The invention relates to “cloud” technologies systems and methods and more particularly to embodiments used to standardize and simplify transactions between the Federal government and entities that do business with it.

### BACKGROUND

Doing business with bureaucratic entities has become increasingly complex in recent years. The foremost example of this ever increasing complexity is the challenge of doing business with the United States Federal Government. The Federal government's use of grants to achieve national objectives has expanded to more than $600 billion, 1,670 Federal grant programs offered by over 20 Federal grant-making departments and agencies. There is an ongoing need to manage the risks associated with administering those funds and provide effective oversight tools. A less obvious problem is the substantial amount of funds that are devoted to administrative actions in managing grants that produce little or no economic value. Similar problems, on a smaller scale, appear in connection with other large bureaucratic entities.

Federal reports required for transparency (including requirements under the American Recovery and Re-investment Act (ARRA) and the Federal Funds Accountability and Transparency Act (FFATA) and proposed in the DATA Act) create additional overlapping requirements for post-award grant reports submission in addition to agency-specific forms submissions. As the government has become more dependent on technology, the convoluted paper forms have not been made simpler. Most agency filing systems require time and money to understand what the government wants, hours to assemble information, and endless efforts re-typing the data that usually come from the filer's computer system into Federal on-line forms at one or more government websites.

Government agencies frequently ask for the same data to be re-entered into multiple Federal forms, and those forms often use different names for the same data. Today's electronic version of government paperwork has become as bad as or worse than days before the Paperwork Reduction Act. Currently, several agencies are revamping their web forms as they upgrade their technology environment. As a result, non-value added paperwork will likely cost more as users learn how to use the new formats, diverting funds from the intent of the government programs. Universities, for example, reportedly spend more than 50% of each Federal research dollar they receive on Facilities and Administration (F&A) costs, and recently have asked for rate increases to cover the rising administrative costs.

### BRIEF SUMMARY OF THE INVENTION

Today's Internet environment offers opportunities to use technology for reducing the cost, complexity, and burden of interacting with government. By leveraging data standards, automated transaction processing, and machine-to-machine communications, a service will be created that reduces the cost and burden of complying with government administration and forms submission requirements. The present invention combines the new economics and scalability of cloud computing with a business model that makes it easier and less expensive for institutions to manage their grants. In particular, the present invention provides a “cloud” and “XML” technologies system and method to standardize and simplify transactions between the Federal government and entities that do business with it, and use of document management technologies to simplify government regulatory compliance. The invention also leverages a “cloud” technology system and method to enable institutions to identify and apply rules and regulations relevant to their interactions with the Federal government, such as those governing specific uses of Federal funds and reporting requirements.

Thus, the present invention provides systems and methods that use “cloud” technologies to standardize and simplify transactions between the Federal government and entities that do business with it. The system may include cloud storage containing data files for account user data, grant reporting documentation and grant results/products; secure storage for user account/e-commerce data and USASPENDING archival data on the grant; and regulatory decision support tools for use among administrators, principal investigators, and program directors. Another embodiment of the invention is a grant decision support engine and method for using it for optimizing use of grant funds that integrates government wide and agency specific guidelines. Another embodiment of the invention is a regulatory assistance engine and method for using it to rapidly identify grant regulatory compliance, reporting, and approval requirements specific to Federal agencies. Another embodiment of the invention is a method for using shared hardware, software and storage resources that communicate through a network to facilitate grant reporting that may include steps of: receiving information from a user; identifying a form to be completed; using user submitted data and previously stored data to automatically generate a form with data input; presenting the automatically generated form to the user for review and additional data input; prompting user to review and provide missing information; receiving additional data from the user; using a compliance review engine to review the form for compliance and to identify gaps or suggestions and, based on the review, prompting the user for additional information or preparing the file for submission; determining whether any agencies require an on-line manual data entry and, if so, using a robot to get data into the agencies that require an on-line manual data entry filing with the government agency.

Exemplary embodiments are summarized hereinafter.

An initial embodiment of the invention is directed toward Federal grants post-award filings because the administrative burden is far too large. Users of the systems and methods described herein will free up a significant portion grant funds for research, while enabling improved compliance with new grants reporting requirements.

The grant administration market consists of two segments: Pre-award (developing, submitting and tracking grant applications prior to a funding decisions by donors); and Post-award (managing funds and project activities and reporting back to donors after awards have been made). The initial embodiment description herein is focused on the post-award segment because it is characterized by antiquated and inefficient systems and bureaucracies ripe for modernization due to growing fiscal and accountability pressures.

One embodiment of the invention is a “digital workspace” for post-award managing and archiving administrative records, filing of government reports, and responding auditor requests for documentation. An additional embodiment of the invention applies unstructured data analytics methods based on a unique process and taxonomy to create a “decision support engine” to simplify search and understanding of relevant Federal rules and regulations. Advantages of the present invention include: Faster, more efficient execution of business transactions; Reduced transaction costs; Reduced administrative burden; Freed up resources for higher value work; Simplification of business dealings with the government and Improved risk management and compliance with Federal requirements.

The system of the present invention is preferably implemented through the use of “cloud computing” using shared hardware, software and storage resources that communicate through a network (preferably the Internet). Cloud computing provides computation, software, data access, and storage services that do not require end-user knowledge of the physical location and configuration of the system that delivers the services. An advantage of cloud computing is the ability to increase capacity or add capabilities as needed without investing in new infrastructure, training new personnel, or licensing new software. Cloud computing infrastructure typically consists of services delivered through shared data-centers and appearing as a single point of access for consumers' computing needs.

The system includes transaction engines that, among other things, 1) Simplify and standardize four common on government regulated processes (post-award grants administration; reporting; records management and retrieval; and grant financial management); 2) address chronic problems in Federal accounting systems accounts reconciliation; and 3) leverage economies of scale and standardization of interfaces to reduce transactions burden, costs, and regulatory compliance risk to groups that conduct financial transactions and/or reporting with the Federal government. These systems will be implemented and made available on the market via commercial software platforms, such as SpringCM or other providers.

Thus, the system for facilitating administrative reporting pertaining to a grant preferably includes cloud storage including data files for account user data, grant reporting documentation, grant audit preparation, and grant results/products; and secure storage and access for user account/e-commerce data, records management and archiving. The system further includes a grant decision support engine for optimizing use of grant funds. The grant decision support engine includes an interface to allow a user to elect to see if there is a warning light for audit risk related to the magnitude of likely unused funds. A processor calculates a warning based on % remaining funds for last phase of grant and the system displays a red flag and risk management language in a report if the percent magnitude of available funds exceeds the percent of time remaining in a grant during the last quarter of the grant.

The system may further include a common language expenditure system for receiving user input of a common language expenditure and correlating the input to regulatory guidance and providing the user with the options of evaluating possible expenditures and Federal controls over those expenditures; or receiving interactive guidance in managing risks of grant administration including issuance of a request for extension for the grant time period and other regulatory approvals.

The method optimizing use of grant funds through the use of a grant decision support engine, includes the steps of receiving an election from a user indicating whether the user elects to see if there is a warning light for audit risk related to the magnitude of likely unused funds; and, if the user elects to see if there is a warning light for audit risk, calculating a warning based on % remaining funds for last phase of grant. A red flag and risk management language are displayed on a report if the percent magnitude of available funds exceeds the percent of time remaining in a grant during the last quarter of the grant.

The method may further include the steps of prompting the user to input a common language expenditure; correlating the common language expenditure input by the user to regulatory guidance and providing the user with the options of evaluating possible expenditures and Federal controls over those expenditures or providing interactive guidance in managing risks of grant administration including issuance of a request for extension for the grant time period and other regulatory approvals. The method of providing interactive guidance in managing risks of acceptability of grant expenditures includes the steps of identifying recent government regulatory compliance and audit issues affecting the institution and asking questions regarding whether grant is experiencing a similar issue, whether controls to address the issue have been applied to the grant program and what portion of grant funds are effected; identifying additional administrative requirements when the ratio of remaining funds to time exceed 1.0, increasing the likelihood of audit; any new categories of spending or sub-grantees spending that were not included in the grant award; and any new subcontractors or sub-grantees that were not included in the grant award.

Embodiments of the invention may also include a method for using shared hardware, software and storage resources that communicate through a network to facilitate grant reporting that include the steps of receiving information from a user; organizing the information using a unique taxonomy and folder structure identifying a form to be completed; using user submitted data and previously stored data to automatically generate a form with data input; presenting the automatically generated form to the user for review and additional data input; prompting user to review and provide missing information; receiving additional data from the user; using a compliance review engine to review the form for compliance and to identify gaps or suggestions and, based on the review, prompting the user for additional information or preparing the file for submission; determining whether any agencies require an on-line manual data entry and, if so, using a robot to get data into the agencies that require an on-line manual data entry; and filing with the government agency.

### BRIEF DESCRIPTION OF THE DRAWINGS

Features of the invention are described more fully in the detailed description and drawings in which:

FIG. 1—is an exemplary screenshot depicting a Grant Administrator's Level Folder Template in the Digital Workspace

FIG. 2—is an exemplary screenshot depicting a Grant Specific Audit Ready Folder Template in the Digital Workspace

FIG. 3—is a swim lane flow diagram showing Grant Documents Upload Functionality in the Digital Workspace

FIG. 4: is a Table of Content Receiving Methods for the Digital Workspace

FIG. 5: is an exemplary screenshot depicting how an Upload icon Browse opens up Windows upload feature on a user's computer

FIG. 6a—is an exemplary screenshot depicting an example email receipt sent to the Digital Workspace “Invoices” Folder From a Cell Phone

FIG. 6b—is an exemplary screenshot depicting an Email Of Two Receipts From Cell Phone Into The “Invoices” Folder For A Grant

FIG. 6c—is an exemplary screenshot depicting an example Receipt from Cell Phone email (Attachment) as Stored by the Digital Workspace

FIG. 7—is a swim lane flow diagram showing Grant Data Capture and Initial Processing in the Digital Workspace

FIG. 8—is a flow chart showing Standard Form Approval Workflow in the Digital Workspace

FIG. 9—is a swim lane flow diagram showing Grant Webform Submission Workflow in the Digital Workspace

FIG. 10—is a table Listing the Data Item Descriptions for the Digital Workspace Financial Report Upload File

FIG. 11—is an exemplary screenshot depicting an Excerpt of the SF-425 CSV file used by the Digital Workspace

FIG. 12—is an exemplary screenshot depicting an Example email of Link to Approving SF-425 sent via the Digital Workspace

FIG. 13—is an exemplary screenshot depicting the SF-425 Review and Approval with Drop down Menu in the Digital Workspace

FIG. 14—is an exemplary screenshot depicting the Approval Process Results

FIG. 15—is a swim lane flow diagram showing use of the Digital Workspace for Responding to a Grant Audit Document Request

FIG. 16—is an exemplary screenshot depicting Document Retrieval and Assembly for the Audit in the Digital Workspace

FIG. 17—is a swim lane flow diagram showing the Process Map of How a User Applies the Decision Support Engine to Determine Allowability of a Desired Grant Expenditure

FIG. 18—is an exemplary screenshot with Explanation of Features and Functions on the User Interface to Run the Decision Support Engine to Understand Allowability of a Specific Expenditure

FIG. 19—is a swim lane flow diagram showing the Process Map of the CSER (Categorize, Search, Extract, Report) Algorithm Used by the Decision Support Engine as Applied For Determining Allowability And Conditions For A Desired Grant Expenditure

FIG. 20—is a Table Showing the Taxonomy Used to Tag Document Fragments

FIG. 21—is a swim lane flow diagram showing a Process Map of how the Decision Support Engine Generates an Audit Risk Warning

FIG. 22—is an Example Report Generated by the Decision Support Engine Showing Content Elements and Links

FIG. 23—is a swim lane flow diagram showing a Process Map of the CSER (Categorize, Search, Extract, Report) Algorithm Used by the Decision Support Engine as Applied For Finding Specific Grant Compliance Requirements

FIG. 24—is an exemplary screenshot with Explanation of Features and Functions on the User Interface to Run the Decision Support Engine for Quickly Identifying Specific Grant Requirements

FIG. 25—is an exemplary screenshot depicting a Report History Generated by the Decision Support Engine that Enables Flexibility, Recall of Past Insights, and Cataloging of Documentation

FIG. 26—is a Table Identifying The Value to Central Administration Provided by the Digital Workspace

FIG. 27—is a Table Identifying The Value to Central Administration Provided by the Decision Support Engine

### DETAILED DESCRIPTION OF THE INVENTION

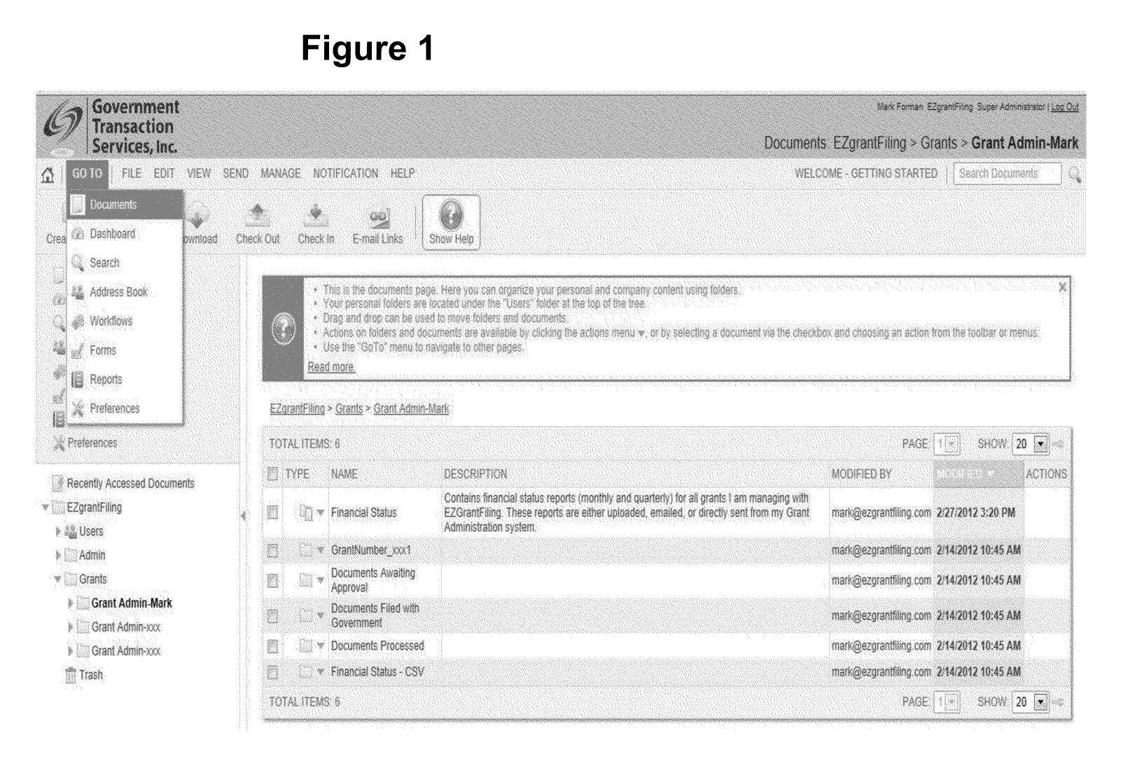

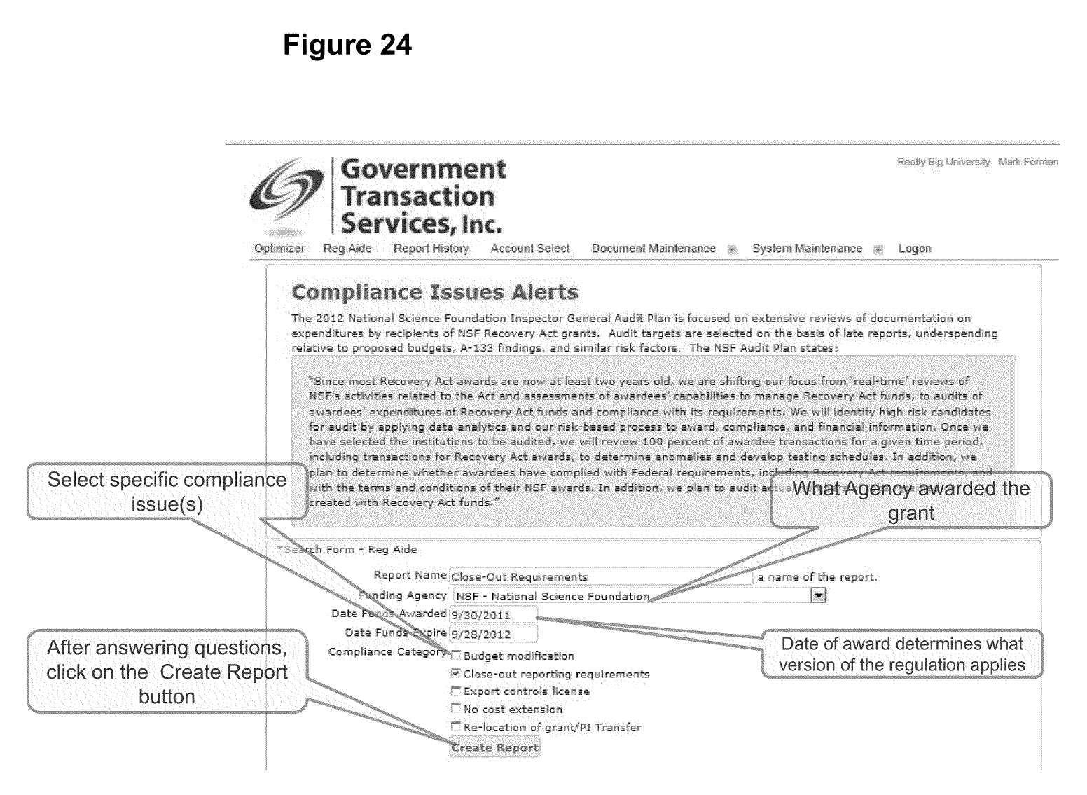

The system and method for supporting a cloud-based business process and transaction services supporting the Federal assistance community is described in detail in the drawings attached hereto as FIGS. 1-27. As shown, the present invention may be implemented in a Software as a service (SAAS) or “on-demand software” software delivery model in which software and its associated data are hosted centrally (typically in the (Internet) cloud) and are typically accessed by users using a thin client, normally using a web browser over the Internet. An embodiment of the invention aggregates SAAS and cloud transaction engines, and standardizes, builds, or otherwise modifies elements of three key processes: 1) Grants management and administration; 2) Regulatory Compliance; and 3) Audit Readiness and Records Management.

Embodiments of the invention also apply cloud computing SAAS models and commoditization concepts to address chronic problems in Federal accounting systems and reduce transactions burden and costs to groups that conduct financial transactions and reporting with the Federal government.

Embodiments of the invention include a Digital Workspace and Archiving System; a Compliance Assistance Engine; and a Federal Grant Report Filing Engine.

Digital Workspace:

One embodiment of the invention is a digital workspace for facilitating administrative reporting pertaining to a grant, that may include cloud storage that includes data files for account user data, grant reporting documentation and grant results/products for user account/e-commerce data and USASPENDING, “Federalreporting.gov, and FSRS.gov” archival data on the grant; and workflow and records management framework for storing and converting documents into Federal reporting. The digital workspace simplifies and streamlines three time-consuming post-award activities: converting manual quarterly reporting into c-filing; streamlining document assembly for responding to auditors, and providing a secure easy-to-use environment for storing, organizing and accessing your important grants documents—from award through record retention.

The digital workspace is a secure digital workspace that includes document management for Federal grants records management and workflow for Federal form electronic filing. The records management capability provides a secure environment for storage and access of important grants documents—from award through record retention. As developed, a user has access to a secure electronic workspace, which is organized with a unique folder structure created to support Federal regulatory compliance, reporting, and auditing. The work space is purchased and configured specifically for the grants that the administrator has designated in the digital workspace subscriptions. The work space contains the ability to upload and download documents, an audit-ready folder structure to organize grant documents, and the ability to customize folders as users may desire in managing each grant's records.

There are two levels of folders provided to a user: (1) grants administrator level contains information from your cross-project perspective (such as reports); and (2) specific grant folders that contain information specific to a single project or grant (such as. SF-424 and related award documentation). For each folder, the digital workspace provides a description, date of last use, and optional email address for receiving documents via email, permissions for access, and audit trail of usage.

The grant administrator level folders are shown in FIG. 1, which is a screenshot of the digital workspace, and are defined below:

1) Documents Awaiting Approval: at each quarter end, as quarterly or annual reports are being prepared for approval and submission, this folder gets populated automatically by the workflow engine. It contains the Federal reporting documents that contain the data received from the institution computer or file upload. A link to each document has been provided to the designated approver at your institution, but any documents that appear in the folder have not been reviewed and approved or rejects.

2) Documents Filed with Government: This folder contains .pdf copies of signed documents that have been approved and submitted to the government. The documents contain the Federal grant ID, reporting period end date, and your institution project ID in the title.

3) Documents Processed: This folder contains Federal reports that have been processed by the digital workspace's workflow and approved or rejected.

4) Financial Status: This folder contains spreadsheets and financial reports on multiple projects/grants. The invention includes a capability for an inbound email address to be added upon account set-up so that the client can email docs to this folder

5) Multi-project Status and Progress Reports: This folder contains progress and status reports on multiple projects. The invention includes a capability for an inbound email address to be added upon account set-up so that the client can email docs to this folder

6) Specific Grant Folders: These folders contain folders for each grant, and will be discussed in detail below. There can be an unlimited number of specific grant folders.

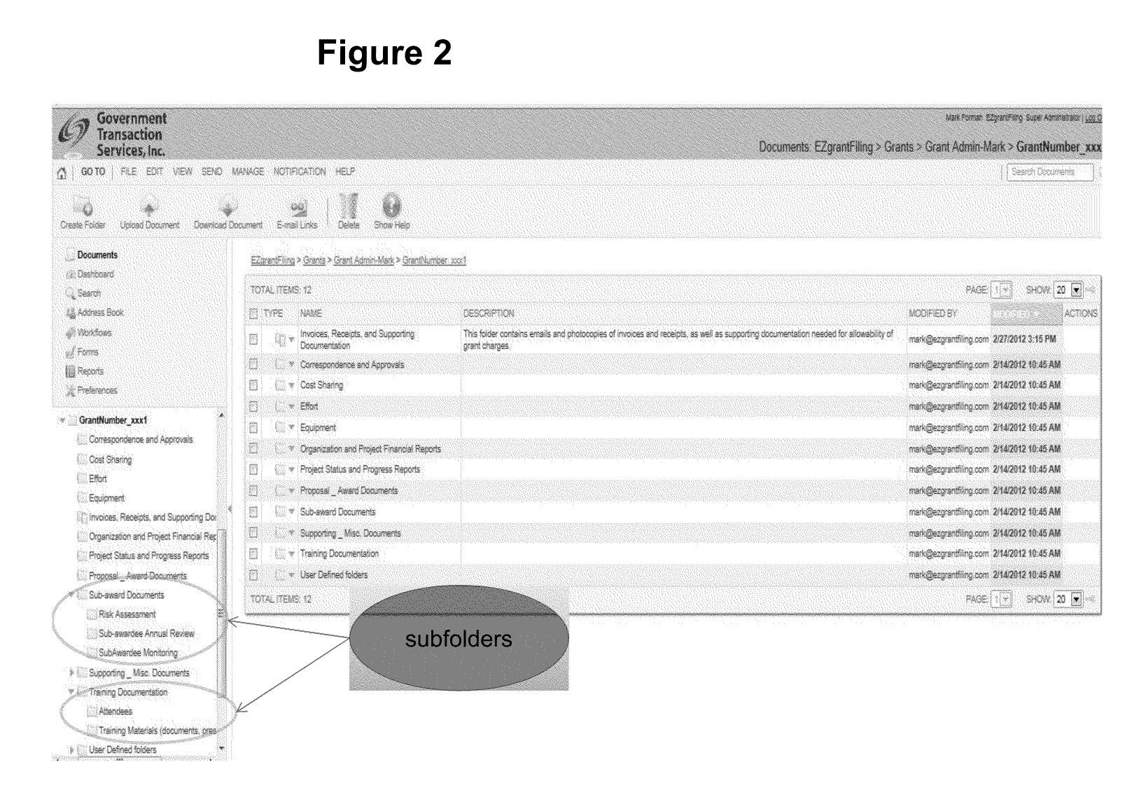

The digital workspace includes a hierarchical set of specially constructed folders for records management on individual Federal grants, as shown in the screen shot in FIG. 2. For each grant, the digital workspace provides a pre-set folder template which provides a unique way to organize and manage documents specific to the government auditing approach for obtaining documentation on a grant. The digital workspace template contains a main grant folder that is named using the project number provided by a user entity to Government Transaction Services when the service is ordered. Under the main folder is a hierarchy of folders organized to support key record retention needs for responding to audit and inspector general requests. As illustrated in the screen shot in FIGS. 1 and 2, folders under a user's name on the left-hand of the screen are organized alphabetically, while folders in the main viewing area are listed in order of most recent usage. The description of each folder in FIG. 2, for each grant, is as follows: |[A1]

Correspondence and Approvals:

This folder contains communications with the grantor agency and others (e.g. subrecipients, auditors) that are part of the official record. The invention includes a capability for an n inbound email address to be added upon account set-up to facilitate use of email for submitting documents to the folder.

Cost Sharing:

This folder contains documentation of planned and actual cost sharing by the grantee institution related to the specific grant.

Effort:

This folder contains documents related to Effort Reporting and related materials needed for an audit and to document personnel charges. The invention includes a capability for an inbound email address and/or fax number to be added during account set-up to facilitate getting documents into this folder.

Equipment:

This folder contains equipment inventory and related lists associated with the grant and related documentation. The invention includes a capability for an inbound email address and/or fax number to be added upon account set-up to facilitate getting documents into this folder.

Invoices, Receipts and Supporting Documentation:

This folder contains grant related expenditure documentation, such as copies of receipts, invoices, emails, or notes to file. The invention includes a standard email address set-up during account set-up to facilitate easy assembly of receipts and other expenditure records. The email address may be distributed to the project team members for facilitating collection of expense receipts for travel and other expenditures to fulfill auditability requirements in users where invoices are not maintained in the central payments system.

Organization and Project Financial Reports:

This folder contains financial reports for the specific grant/project for a given fiscal year.

Project Status and Progress Reports:

This file contains project and status reports for the specific grant, such as the Performance Progress Report or Research Performance Progress Report elements.

Proposal and Award Document:

This folder contains the SF-424 award document, approved proposal, budget and schedule, and award amendments from the grantor agency. The invention includes an inbound email address that may be added upon account set-up so that the client can email documents to this folder.

Subaward Documents:

This folder contains sub-award data and documents, such as proposals, bills, correspondence, start work, termination notices, budget modifications, etc. An inbound email address should be added upon account set-up so that subawardees can email documents to this folder % in addition to contractual-type information typically that would be stored in this folder, the folder template provides three sub-folders that represent the primary types of subawardee documentation identified as critical by government auditors: Risk Assessment (documentation that the grantee assessed the risk that the sub-awardee would be able to appropriately manage Federal funds and deliver as required); Sub-Awardee Annual Review (documentation that shows the grantee is conducting an annual review of the sub-awardee A-133 or annual financial audit findings); and Sub-Awardee Monitoring (documentation that shows the grantee is periodically reviewing the use of funds, including such items as reports from site visits and meeting notes from on-site or off-site discussions).

Supporting and Miscellaneous Documents:

This is a generic repository for documents related to the specific grant.

Training Documents:

This folder contains documents that demonstrate training in grants administration policy and procedures (e.g. time and effort reporting, subaward management, expenditure policies, ethics, lobbying). The invention includes sub-folders to address key audit documentation requirements for training materials and documentation that people working on the grant have attended training.

User Defined Folders:

Additional folders can be added by clicking the create folder menu-bar button.

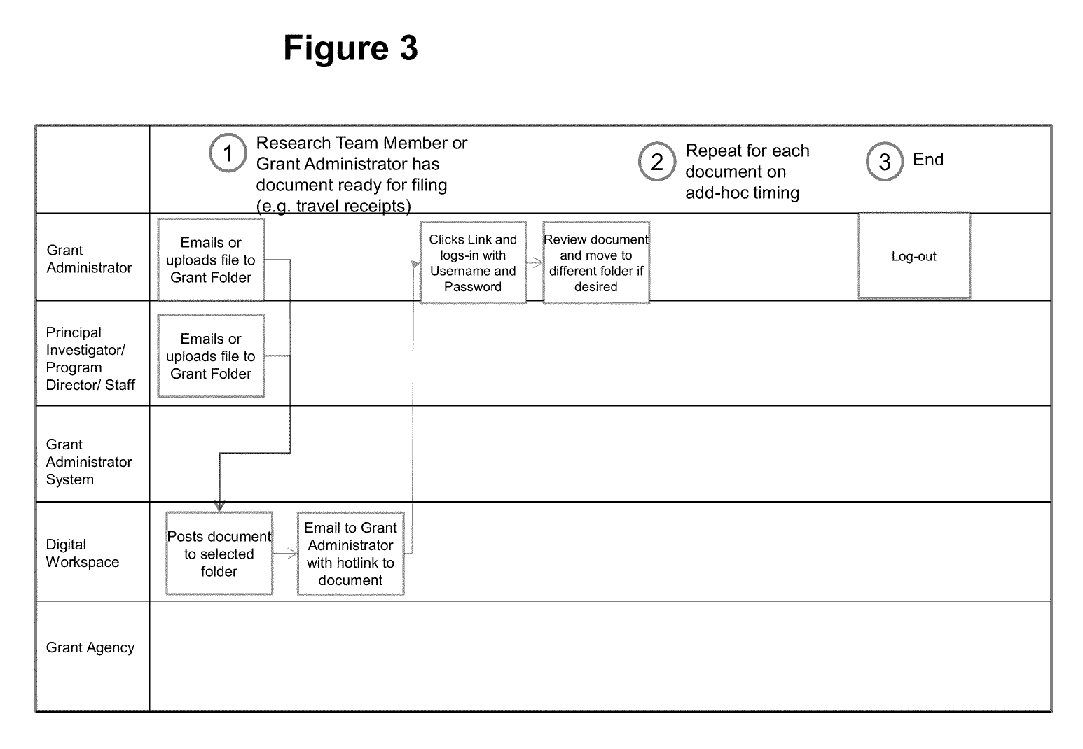

The invention includes multiple options to electronically transfer documents into the digital workspace folders. For example, the invention includes a standard Microsoft upload window for secure upload from a user's computer. FIG. 3 is a process map of the document upload functionality provided by the digital workspace to make it easy for a user and colleagues to obtain and manage key grant documents needed in support of a Federal filing for purposes such as preventing a violation of the False Claims Act. This invention is unique in that it simplifies, reduces cost of assembly, and improves data quality and completeness in the long-standing practice of using a mix of paper folders and personal computing device storage, sometimes supplemented by scanning software, maintained independently by different administrators and grant project staff.

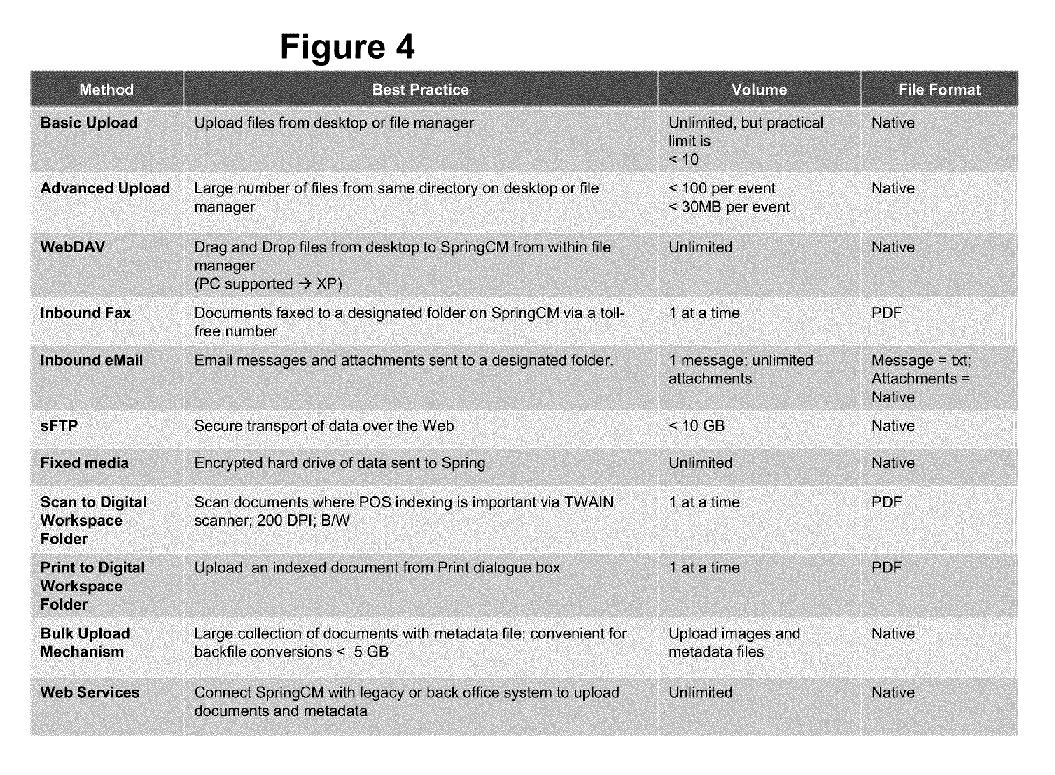

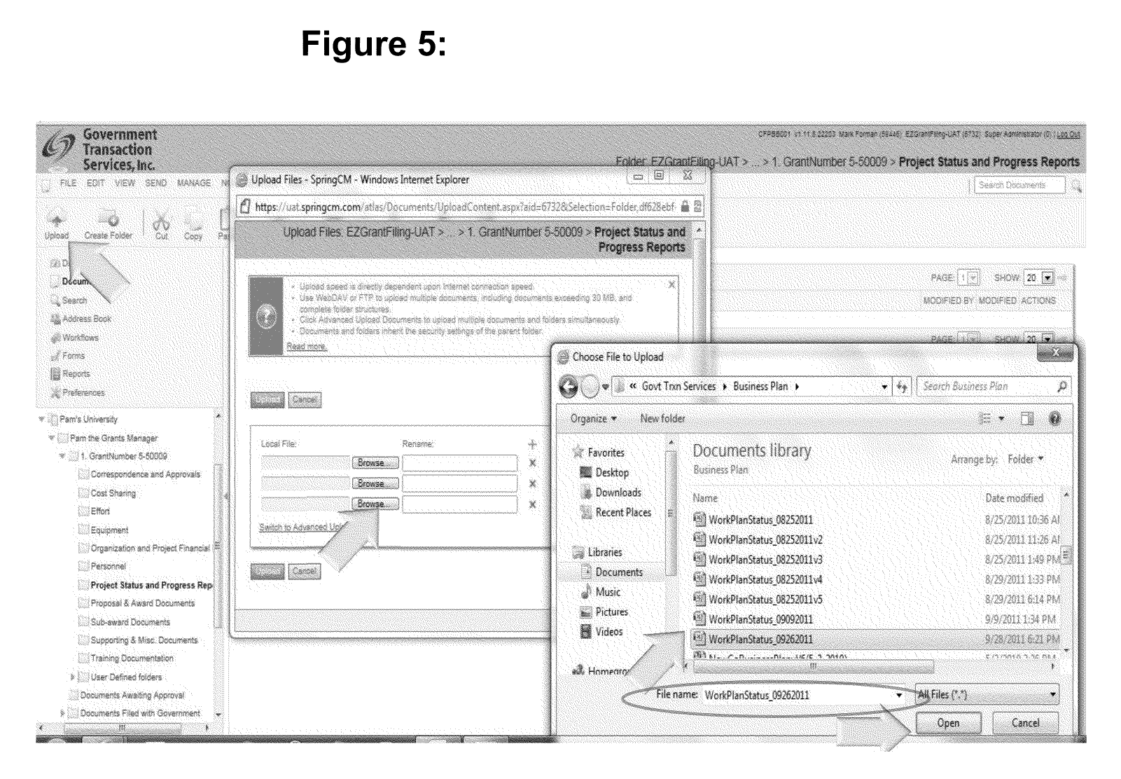

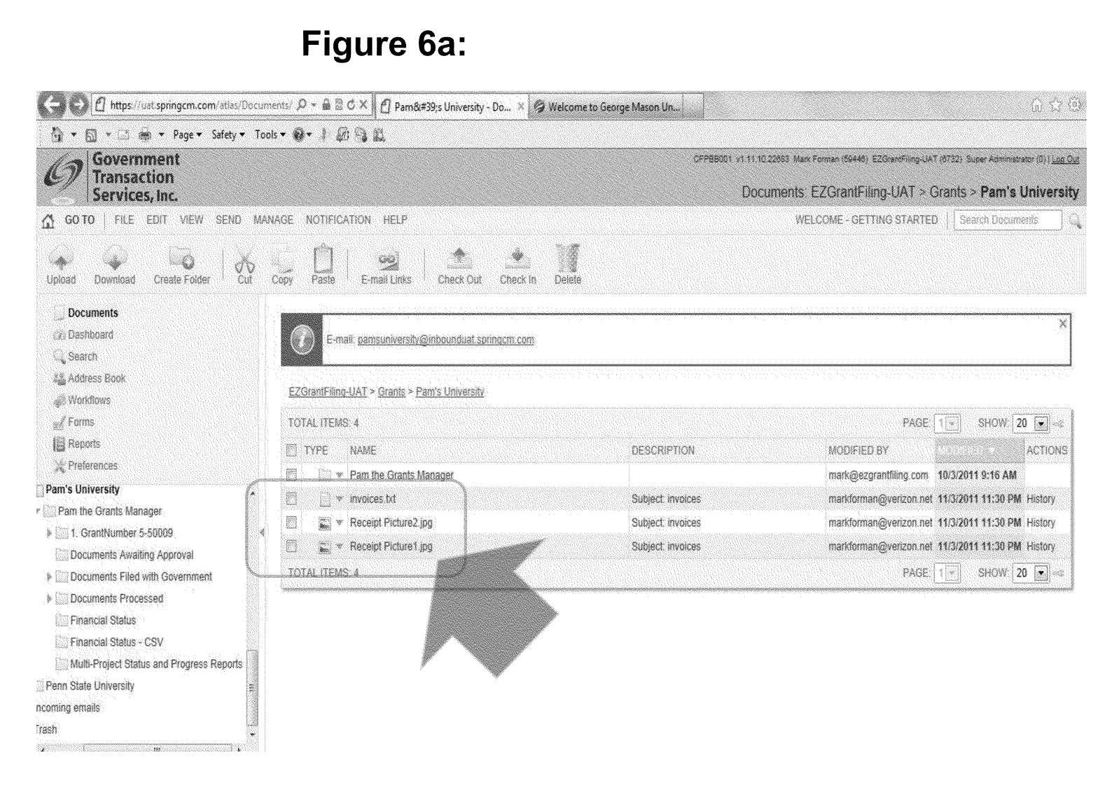

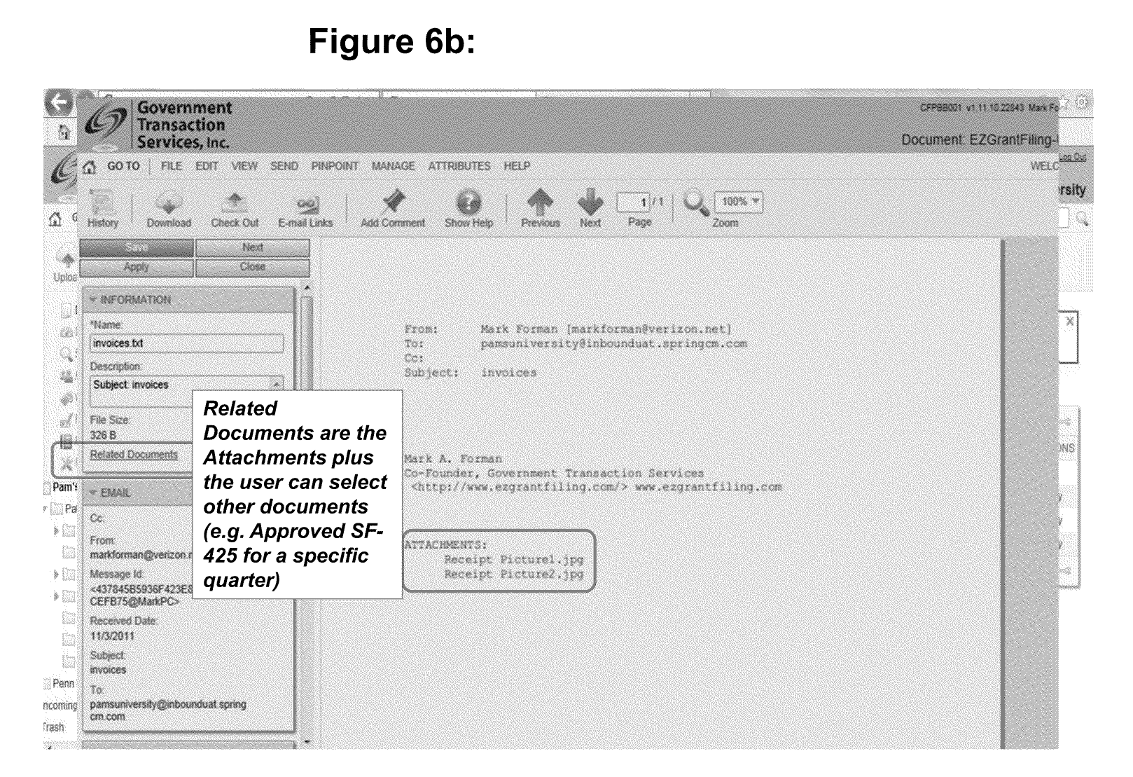

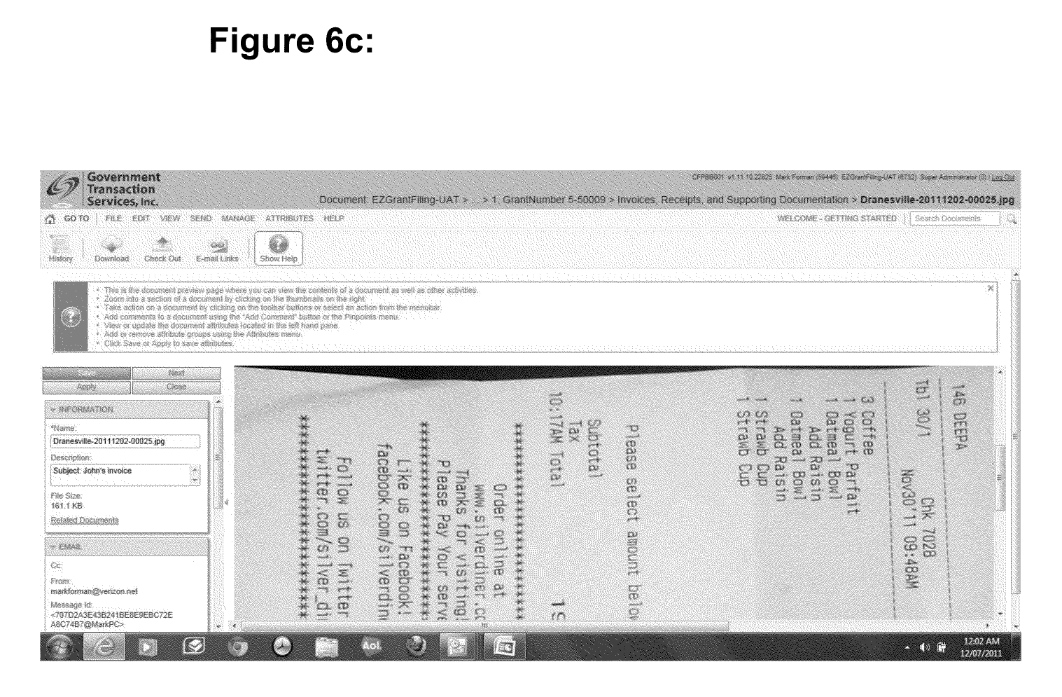

FIG. 4 is a tabular list of the different methods that can be used to upload data into the digital workspace folders as implemented in a platform such as SpringCM. FIG. 5 is a screenshot that illustrates the invention's use of an Upload icon button to open a standard Microsoft upload window on a user's computer to upload documents into a digital workspace folder. FIGS. 6a and 6b are screenshots that illustrate the invention's use of a folder's email address to facilitate “users” submitting documents to a folder as implemented using a document management platform such as SpringCM. The email document shown in FIG. 6b contains the time and date of submission to the folder, and the receipts are linked as “related documents” with the file names listed as “Attachments” in the email document. FIG. 6c is a screenshot of the actual receipt as filed in the folder via email.

The invention includes the ability to link the receipts or other documents to the SF-425 Federal Financial Report in order to facilitate auditability. When a document is submitted to a folder, the invention includes a notification to the grant administrator which can be provided daily, in real time, or none. The invention allows for different notification settings for each folder.

The invention creates a new and unique capability for electronic creation, approval, and system-to-system transmittal of government required reports. The invention includes workflow tools which automate the translation of grantee financial and related project status data into Federal grant administration report formats. The invention incorporates a specially developed workflow implemented using a document processing platform (such as SpringCM) to quickly route reports to approvers for review, certification, and submission to the grantor agency, saving valuable resources from being wasted on the current rote activities of manually printing a report from a grant administrative system (such as financial management software) and typing the data into government websites. The invention removes the need for manually logging into agency grant websites (such as the National Science Foundation Research.gov website) and entering data. In addition, the digital workspace supports hardcopy and electronic (.pdf) submission of the signed forms for agencies (such as National Institute for Food and Agriculture) that accept hard copy.

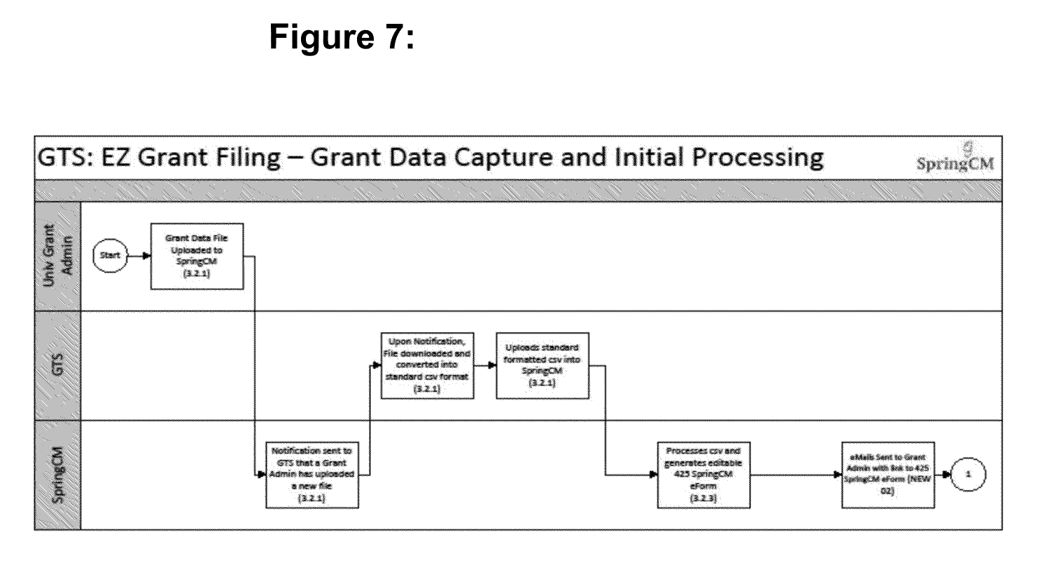

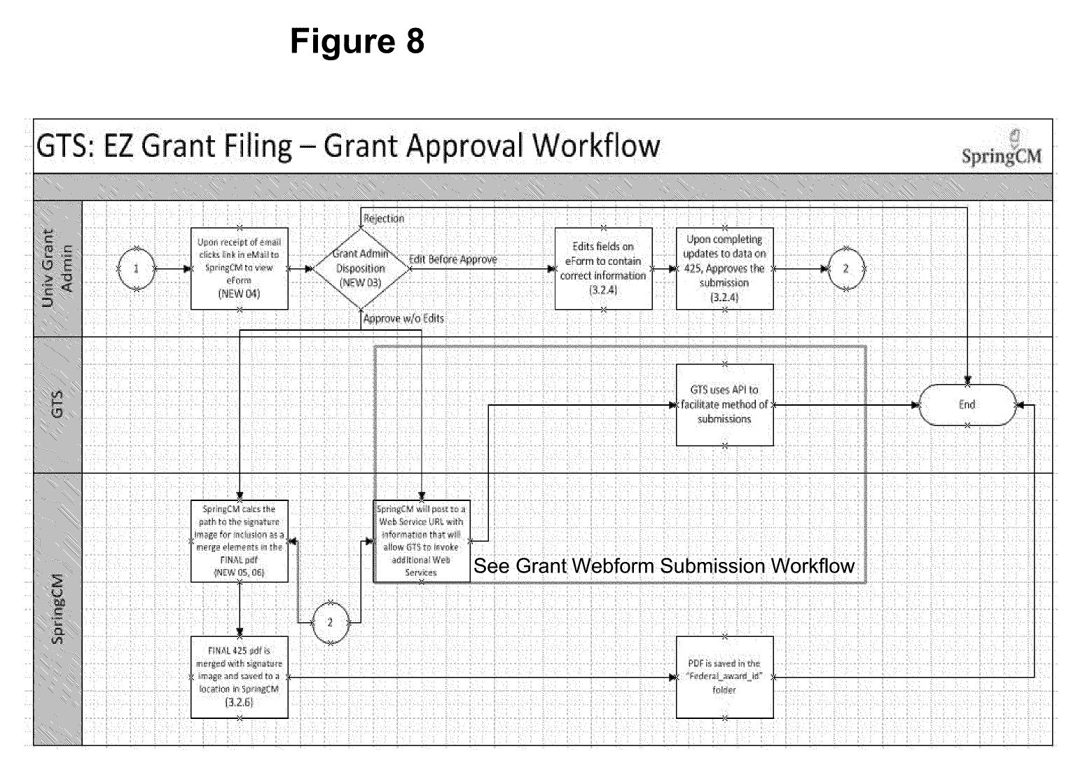

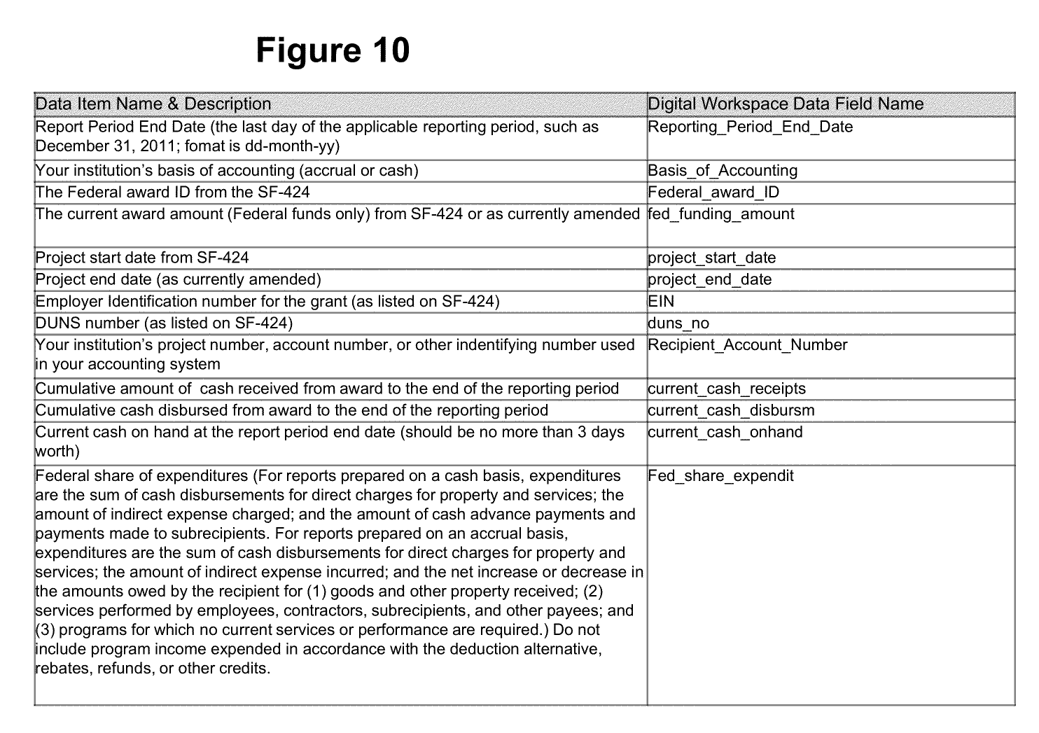

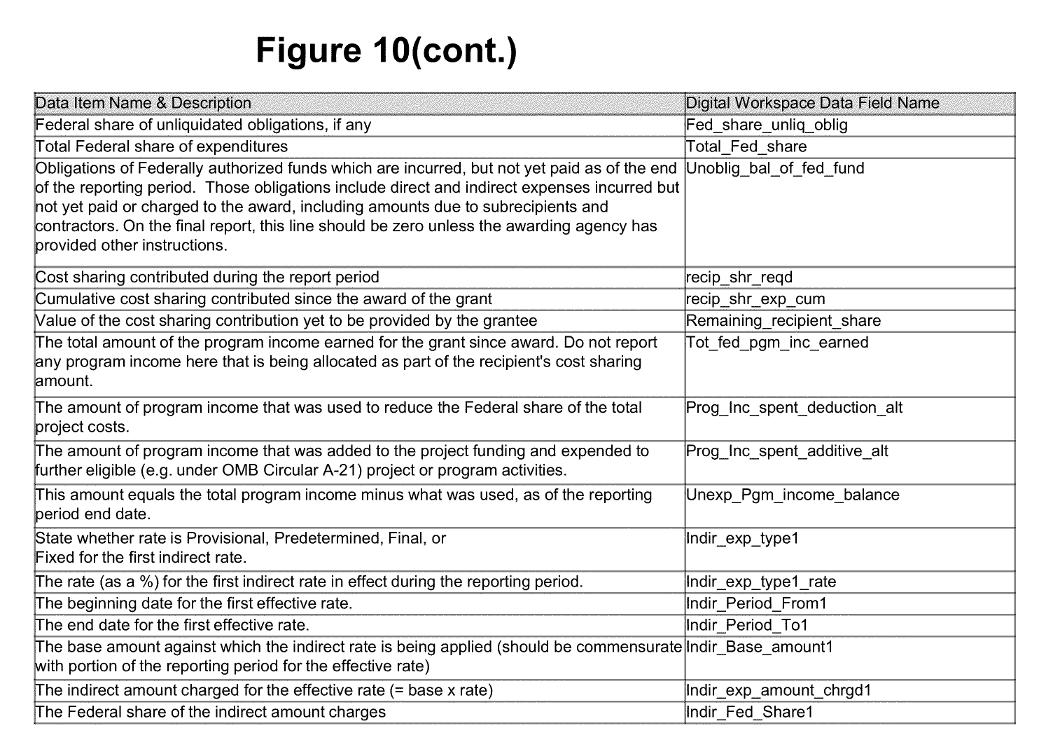

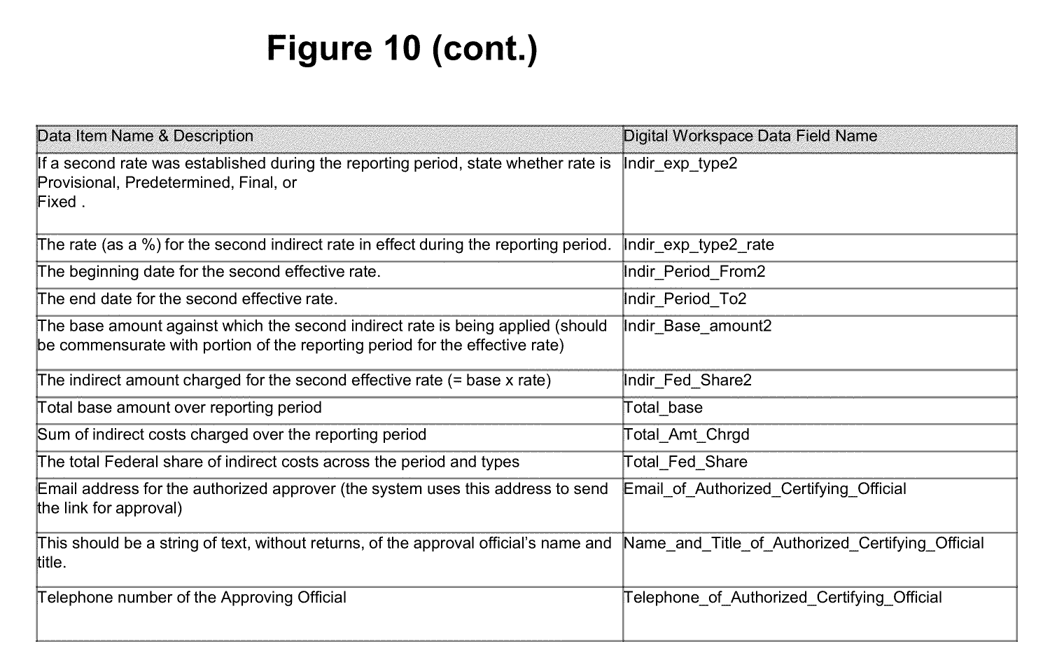

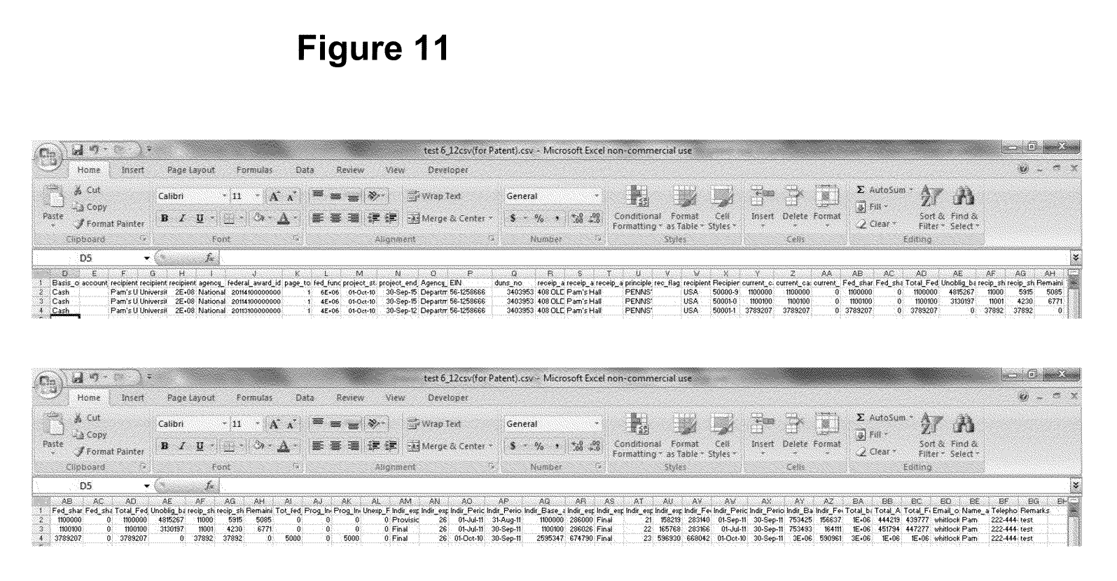

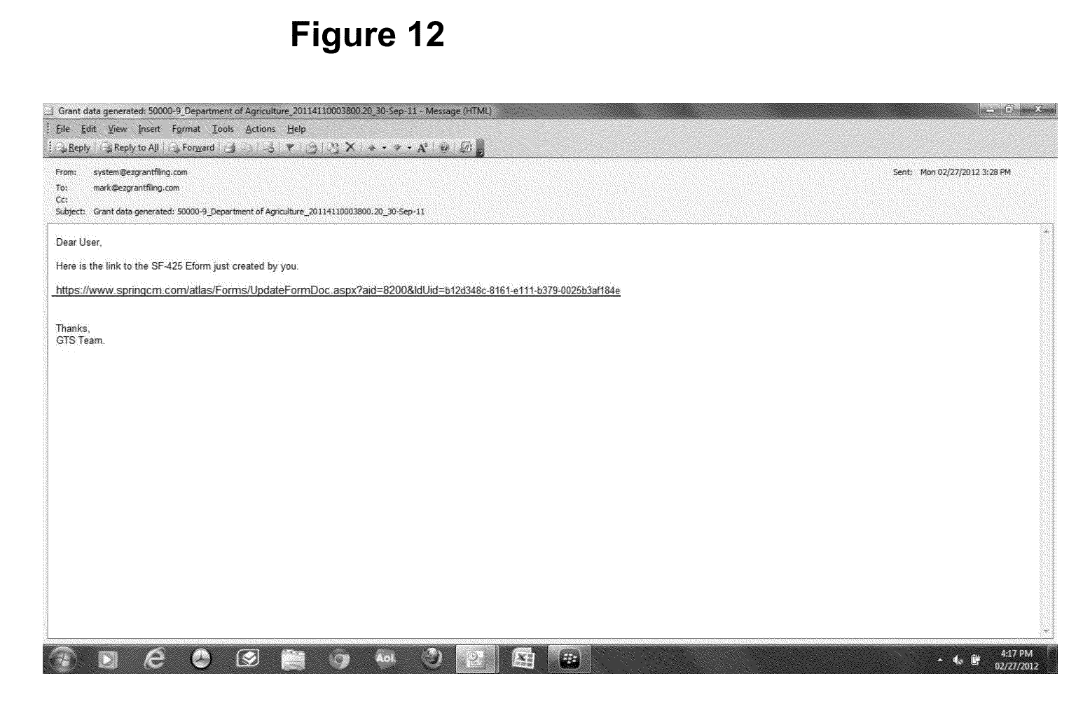

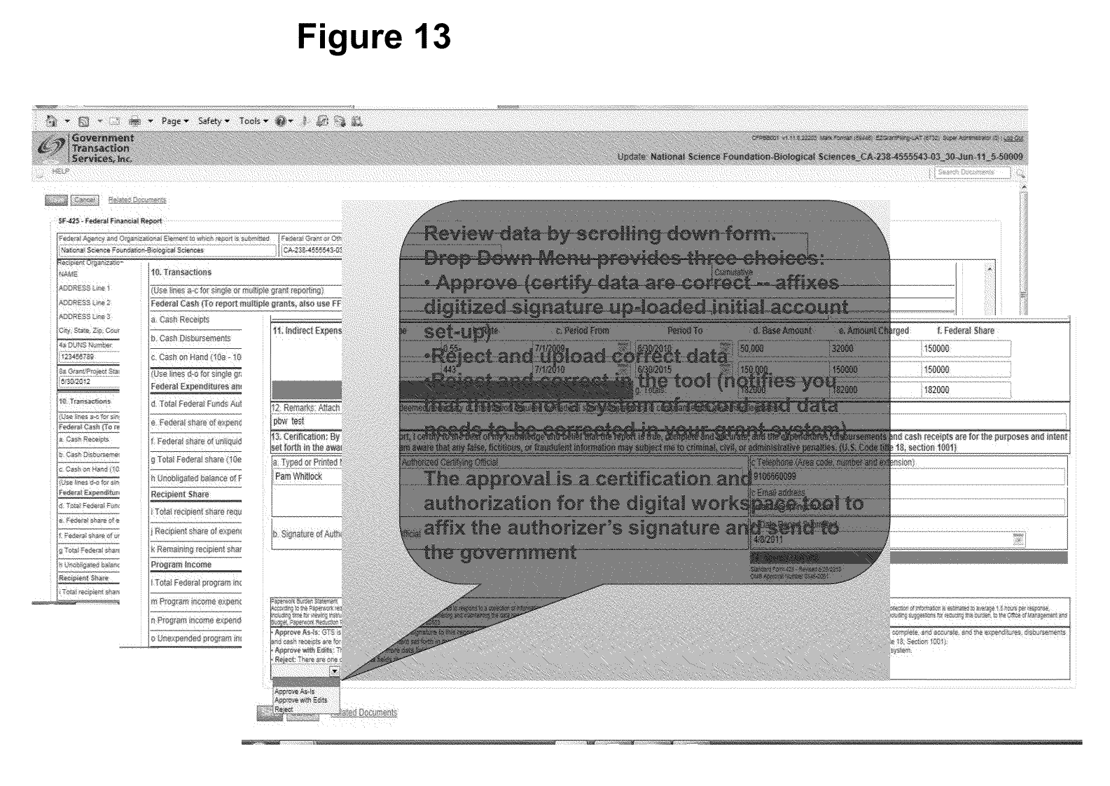

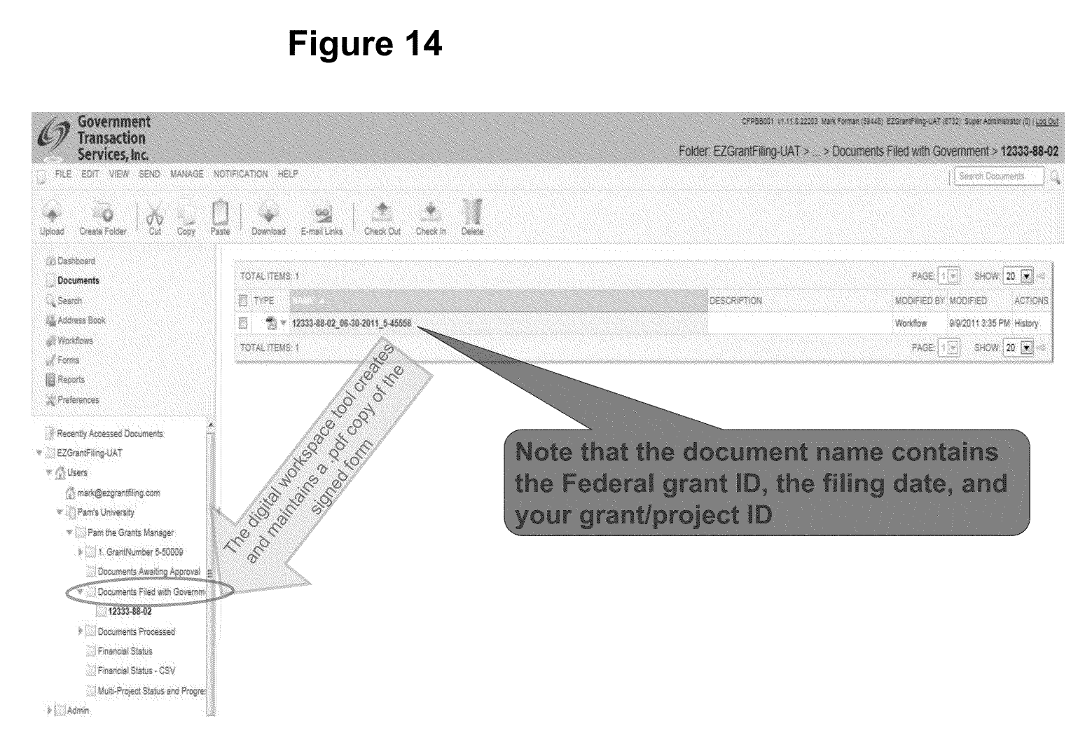

FIGS. 7 through 9 are the data and workflow processes used by the invention for electronic filing of a government report, the SF-425 Federal Financial Report. In the invention, a user designates an approving official associated with each grant. The approving official's digitized signature is obtained and stored in that grant top-level folder. The digital workspace will intake data using a standard format (CSV of Excel spreadsheet) produced by the user institution's accounting or grants administration system regardless of manufacturer. FIG. 10 contains the data items used in the electronic filing workflow. The invention may use the notification procedure outlined above whenever such a file is uploaded to enable Government Transaction Services personnel to conduct a review of the data for completeness. Once complete, the file is loaded into the workflow engine, and an email with a hotlink to the SF-425 is sent to an approving official. FIG. 11 is a screenshot of a standard file that may be fed into the workflow engine in the digital workspace. Once loaded, the digital workspace follows the process defined in FIG. 7 to convert and consolidate the data into an XML object. This portion of the process pauses and sends an email to the person listed in the system as the approver for that grant. FIG. 12 illustrates the email sent to the approving official generated by the invention. When the approving official clicks on the link, a browser window will open on their computer requesting log-in. Upon log-in, the approver will see the SF-425 for review and approval. As shown in the screenshot in FIG. 13, the invention contains a “drop down menu” that enables the approver to Approve, Reject, or Approve with changes to one or more fields. The invention includes language with the menu stating that Acceptance means that the approving official certifies the report to be true and accurate in compliance with the False Claims Act and the approving official authorizes Government Transaction Services to submit the form to the government on his or her behalf by selecting Acceptance. The invention further includes a disclaimer that the report document is not a system of record and that any changes have to concur with the institution's accounting system of record. FIG. 13 illustrates the approval menu for the SF-425 Federal Financial Report. Upon Approval, the workflow continues along the process in FIG. 8, integrating the signature into the XML object, then in parallel, the invention affixes the signature of the approving official and generates an XML file and a .pdf file of the Federal report. The invention uses a unique naming convention to facilitate search and assembly of Federal reports, with the .pdf file name including the Federal award ID, the reporting period end date, and the institution grant or project ID. The approved .pdf file is entered into the folder “Documents Filed with the Government” as illustrated in the screenshot in FIG. 14. If the document was rejected, the invention includes a comment box so that the approving official can explain why the document was rejected.

If the approver rejects the form, upon saving, the form will be routed to the grant administrator “Rejected” forms folder and an email will be sent to the administrator alerting them of the rejected form and providing a link to the rejected form and comment box explaining the reason for rejection.

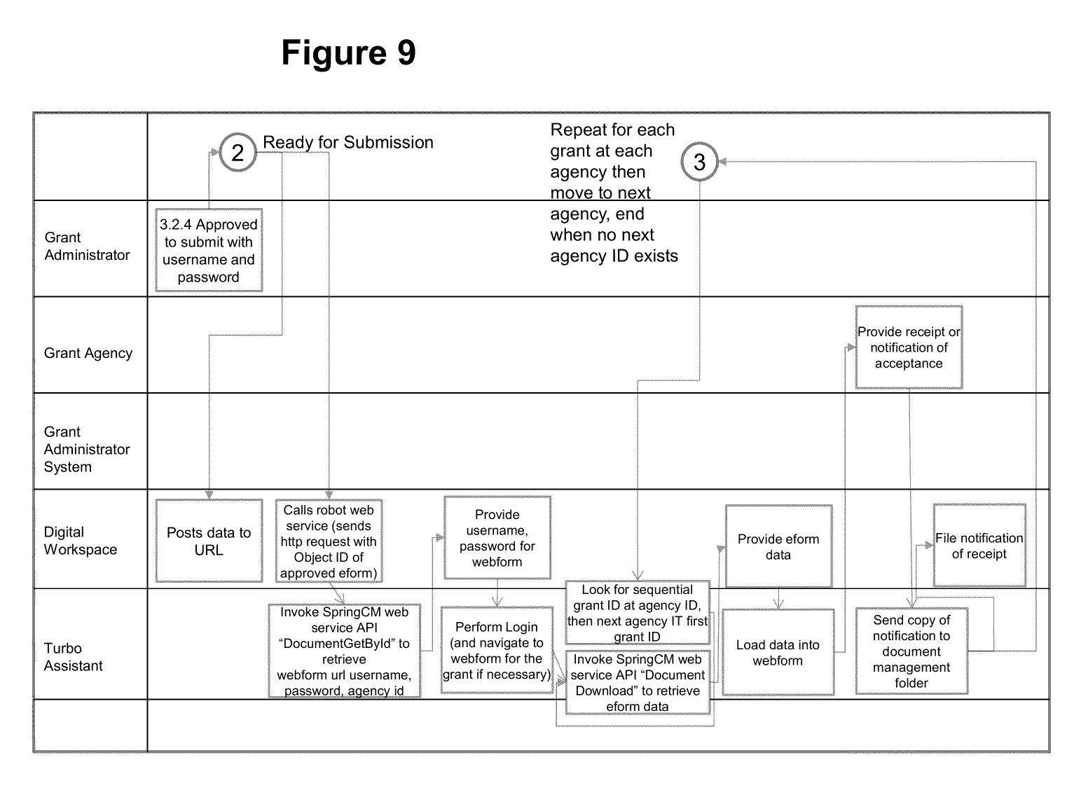

Per the process in FIG. 9, the invention includes a variable method for submitting approved forms to the Federal government in three formats as depicted in FIG. 8; hardcopy/email attachment, XML file, or Webform manual entry. The invention includes a database of grantor agency receiving mechanisms, such as Webform or XML file for the National Science Foundation (NSF), as well as the status of the receiving mechanisms (e.g. NSF has created but not activated the ability to receive data electronically). For agencies that accept a hard copy or .pdf email attachment of a signed form, the invention sends the document electronically as an attachment or by hardcopy as a printed form to the address listed in the database. For agencies that accept an electronic file in XML format, the invention includes an XML tool, implemented in a software platform such as Altova, to convert the XML document produced by the workflow engine into that agency's unique XML schema. The tool includes software configured to uniquely take data from the digital workspace approved XML document, map it fields and data items defined by a government agency, and automatically execute the data transfer repetitively in a secure manner.

For agencies that require a user to log into a website and manually fill-out a form, as

FIG. 9 further explains, the invention includes a software robot (Automated Data Submission System (ADSS) implemented in a software platform such as Siber Roboform) to (1) log-in at multiple government websites using the grantee's user credentials, (2) extract data from the XML document produced by the workflow engine, and (3) fill-in the data at the appropriate fields on a specific agency Webform. The invention includes taking a screenshot of the completed Webform and receipt of submission, and then sending those screenshots to the Submitted to Government document folder for that grant. The Grant content, Login credentials, and Grant Agency URL are retrieved by ADSS from the digital workspace using a set of standard APIs. The results of the submission (screen captures) are stored in the digital workspace in the specific grant folder.

By converting the approved financial report into a single XML object, the invention provides two unique advantages over existing approaches to filing federal reports. First, given the redundant and overlapping nature of federal reporting at the grantor agency and other government filing forms (such as FSRS.gov and federalreporting.gov), the invention's single XML object consolidates multiple activities (including certification, signing, and approval for submission) and replaces the multiple times a grant recipient has to enter, certify and sign the data at different government websites. Using the invention saves significant redundant manual labor because the single XML object with attached signature can be sent electronically in whole or in part to the multiple websites (e.g., nih.gov, fsrs.gov, and federalreporting.gov) as if it were different federal forms. Second, the invention cures a major financial reconciliation issue caused by manual data entry errors that frequently occur in re-typing, data redundantly into multiple website forms. Having one clean image of data to submit electronically removes the need to investigate which website form was the source of manual typing errors.

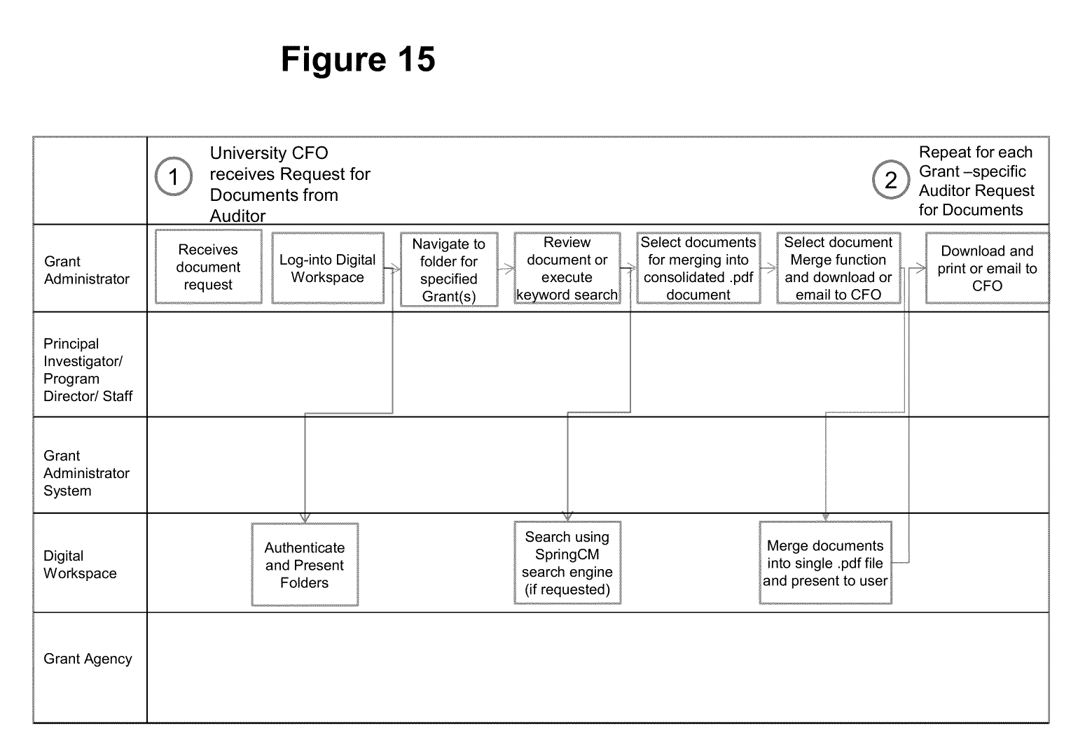

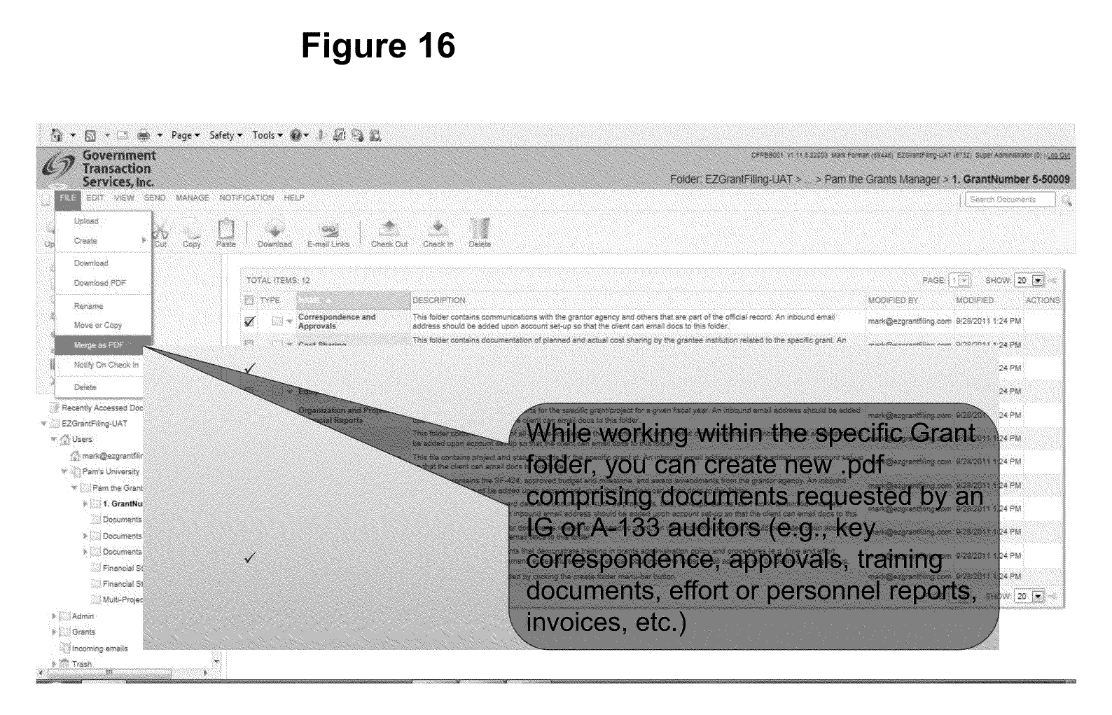

The digital workspace provides an “audit ready” folder structure to reduce the time, cost, and burden of responding to auditors. Ideally, key records, such as correspondence, travel receipts and certified forms, are being uploaded or emailed to the appropriate grant folders on a regular basis. In general, an A-133 or agency auditor will submit its “Provided By Client (PBC)” document request as part of the pre-site visit letter. Using the document request, the invention enables a user to access the relevant files, left mouse click to place a check mark in the boxes by documents, and select the “Merge as a pdf” item from the “File” menu item. FIG. 15 provides a process map of the invention as used to support audit requests. With PBC document request list in hand, the user can either navigate to specific folders (e.g., Invoices) or search a term in the digital workspace to find relevant documents. Missing documents can be collected and organized using email or other upload options described above. The next step is to select the documents and merge the documents selected into a single document that can be printed or electronically sent to an internal action officer or the auditor. FIG. 16 is a screenshot that illustrates the selection of documents and document merge function as implemented in a platform such as SpringCM.

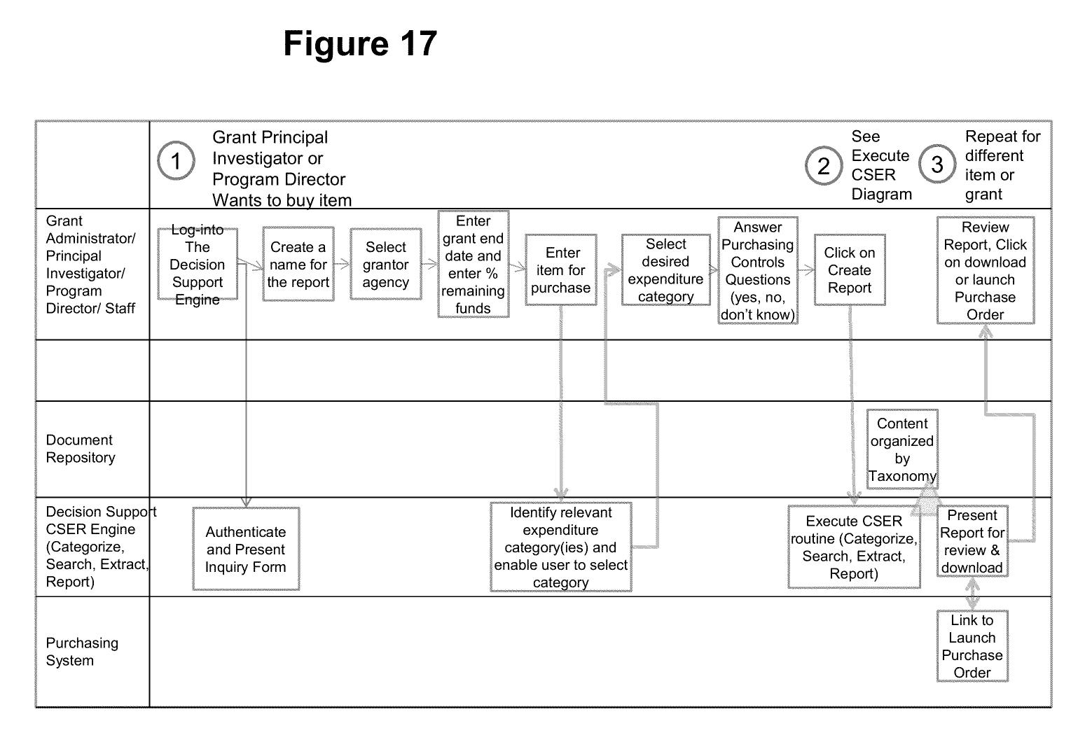

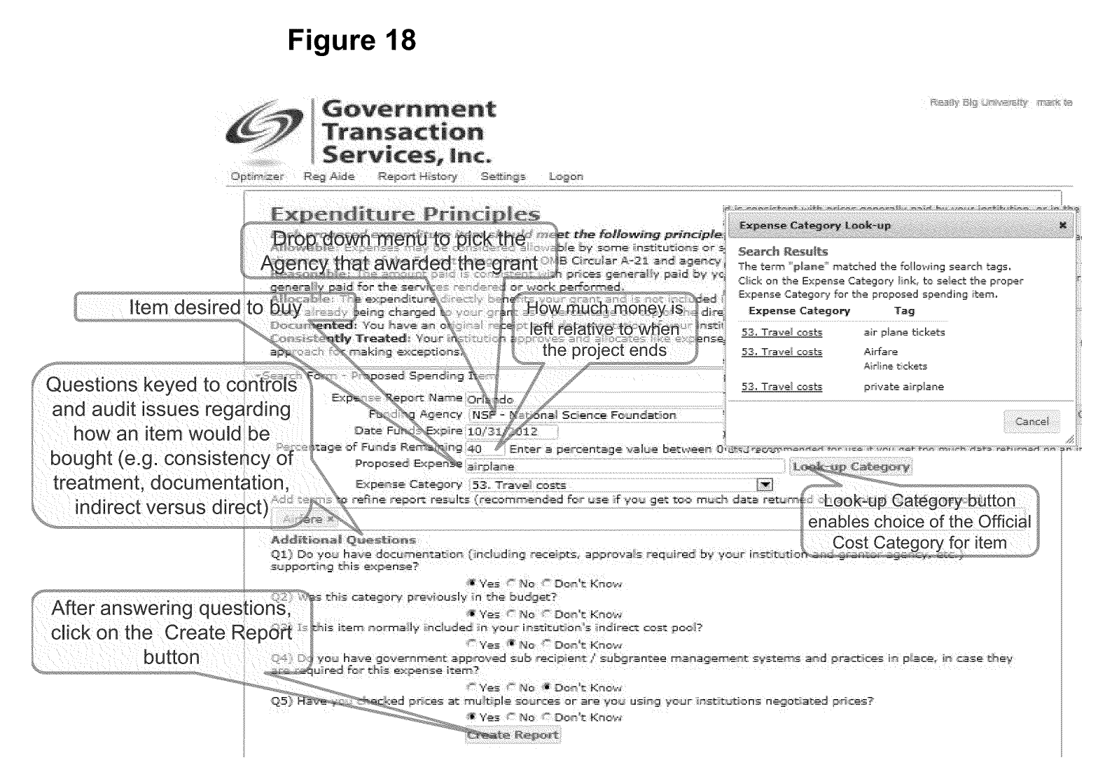

Another embodiment of the invention is a grant Decision support engine and method for using it to optimize the use of grant funds. The grant Decision support engine is a unique decision support tool that provides detailed insights into specific regulations and audit considerations regarding allowable use of remaining funds and providing the user with the options of: identifying legitimate uses of the funding; evaluating possible expenditures; or providing interactive guidance in managing risks of acceptability of grant expenditures, FIG. 17 illustrates the workflow of the Decision support engine. A user logs into their account, creates a name for the report, enters a common language term for what they want to buy, and then answers several questions. Pushing the “Create Report” button generates a report which then appears in the user's internet browser. FIG. 18 is a screen shot of the Decision support engine start form with explanations of the various fields. After log-in, a user names the report to be created, selects the name of the grantor agency from a drop down list, enters or selects the grant's expiration date, enters the percent of funding that remains, and, then enters the name of the item that the user wants to buy. Based on the item name, the invention performs a search of document fragments which have been tagged and stored in a database that relates common language tags to official regulatory terms. The user selects the Federal Expenditure category as defined in government regulation (e.g., OMB Circular A-21, Section J) and then answers a list of questions regarding compliance with controls over the purchasing process. As illustrated in the screen shot, the user may enter “yes”, “no”, or “don't know” to the questions.

The invention uses a knowledge algorithm called CSER (Categorize, Search, Extract, and Report) that has been created to identify specific fragments of relevant guidance on whether a desired purchase is allowable and under what conditions (e.g., whether requirements exist for documentation, approvals, use of competition, etc.). CSER comprises the following components:

Categorize:

A search form/questionnaire (such as that illustrated in the screen shot in FIG. 18) identifies both the proposed expenditure and key process elements of the buying approach (e.g., complies with an approved budget category); the categorization reflects tags that have been applied to regulatory documents;

Search:

Search key document fragments in a database (A-21; A-110; agency guidance; award documents; audit reports; user institution guidance) using a taxonomy of tags that has been linked to each document fragment;

Extract:

Assemble tagged document fragments into a new document file;

Report:

Present the new document file in a standard report format for viewing with an internet browser and downloading in the .pdf format.

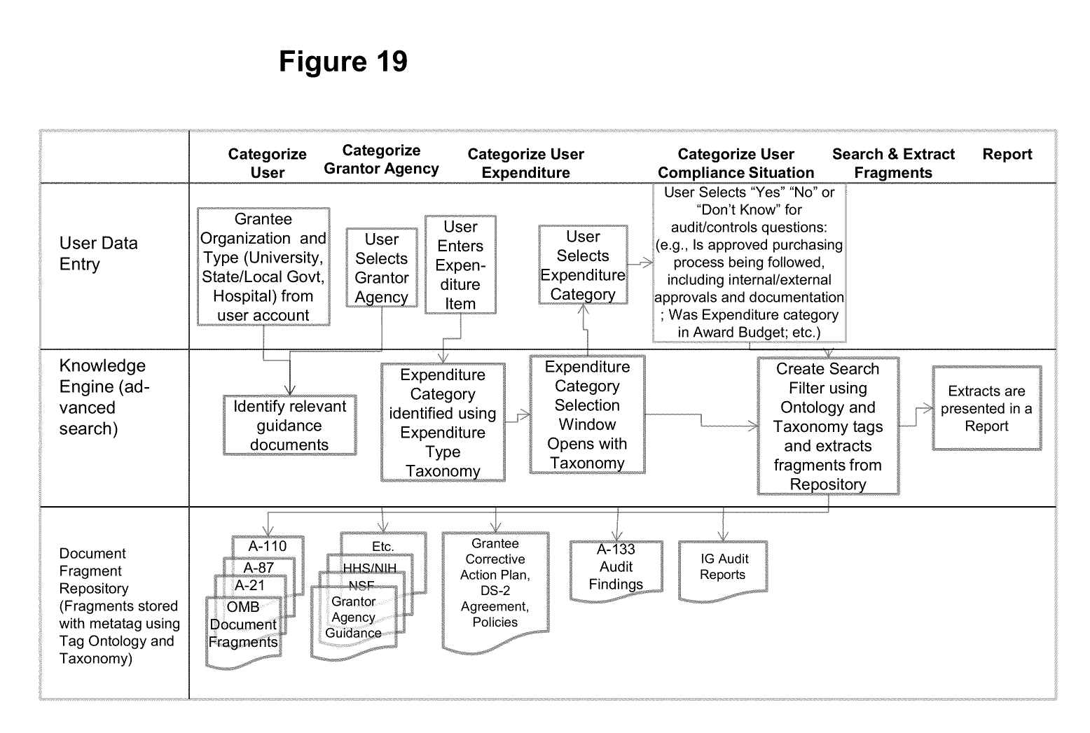

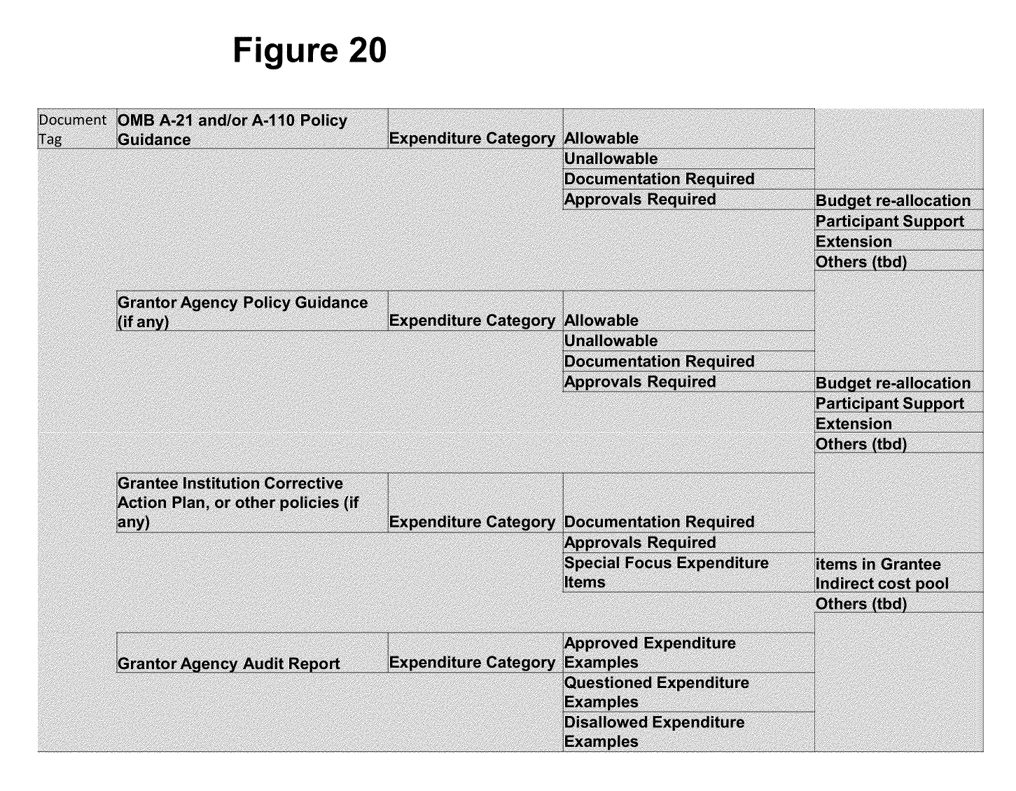

FIG. 19 provides a process map detailing how the CSER algorithm works to develop report content by correlating the user entered data to fragments of regulations, audit reports, and institution specific documents. FIG. 20 is a table containing the taxonomy that may be used by the CSER algorithm and by an administrative user to tag document fragments in building the database.

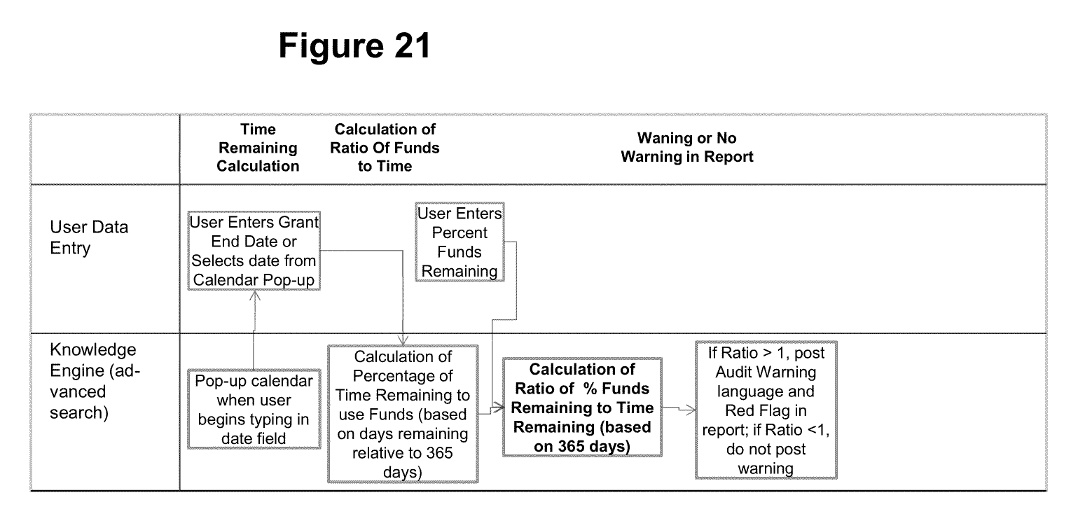

The invention produces a report that contains the user-entered data, name and date of the report, and lists specific regulatory and audit document fragments resulting from the search. The report may include a warning flag and statement of certain risk management actions to be taken. The determination of whether the warning applies is based on an algorithm that compares remaining funds to time before the project ends, or other criteria, as defined by auditors. FIG. 21 illustrates the process for determining whether to include the warn flag and language in a report.

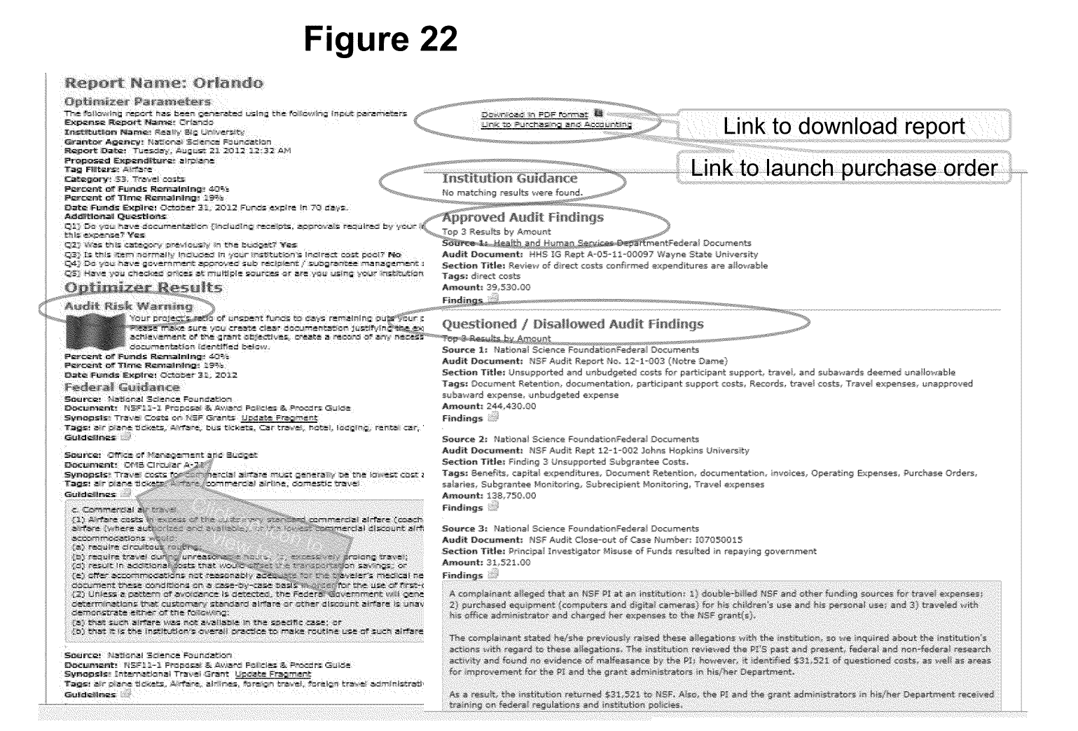

FIG. 22 presents an example screenshot of how The Decision support engine generates a Report to be viewed using an internet browser. The report also may be rendered and downloaded as a .pdf document. The invention may also include a link for a user to launch a user institution's purchase order to acquire the item being considered and attach the report as evidence of due diligence.

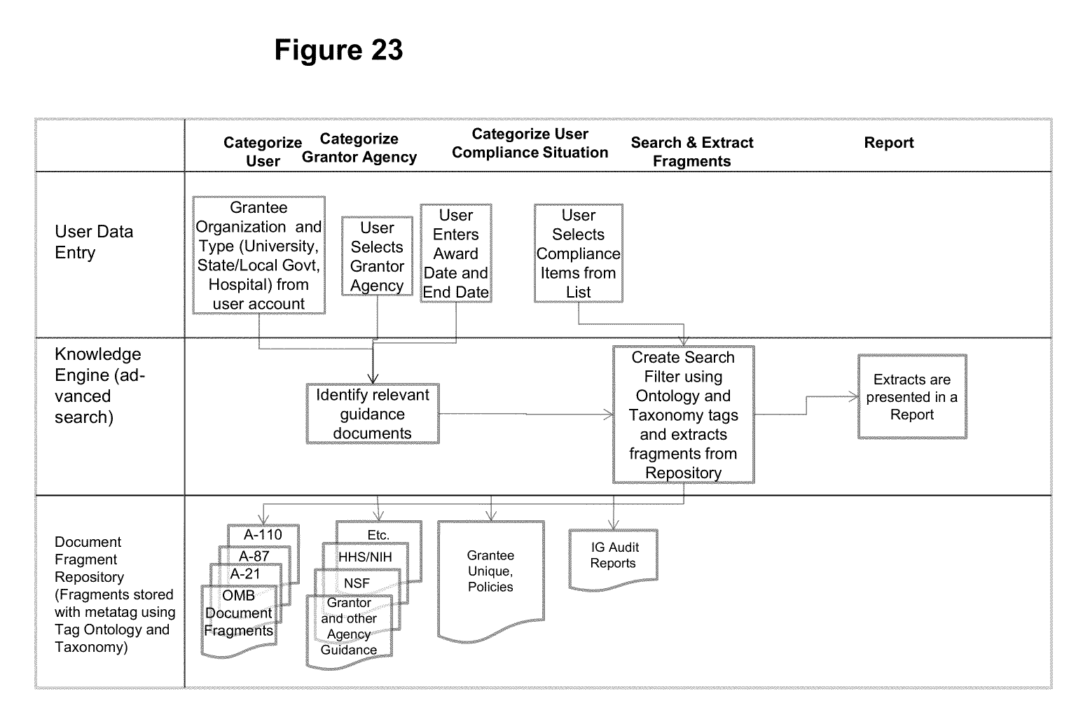

The invention includes a second regulation compliance assistant decision support engine and may send “Compliance Issues Alerts” to advise grant recipients about new grant administration regulations and emerging issues that auditors have highlighted as a focus of their audits. The invention applies the CSER algorithm to invite the user to identify particular areas of regulatory content for focused queries, using a process such as illustrated in FIG. 23. These areas may include, but not be limited to: budget modification, close-out reporting requirements, export controls license, no-cost extension, re-location of grant/principal investigators transfer. FIG. 21 is a screen shot of the form that a user fills-out to create a regulation compliance report for a given grant. With this embodiment of the invention in the decision support engine, the Report also appears via an internet browser and may be downloaded as a .pdf file.

The queries made using the decision support engine may initiate an automated search of relevant content maintained in a data base, or “tag library,” populated with excerpts of relevant government regulatory language. The method of providing interactive guidance using CSER may be adjusted to include examples such as, but not limited to, the following: comparing expenditures by categories to awarded program budget, and written requests for budget changes submitted to the grantor administrator; identifying recent A-133 audit issues affecting the institution and asking questions regarding whether controls to address the issue have been applied to the grant program or a given expenditure would create a related issue; creating a new category of spending that was not included in the grant award; or adding any new subcontractors or sub-grantees that were not included in the grant award.

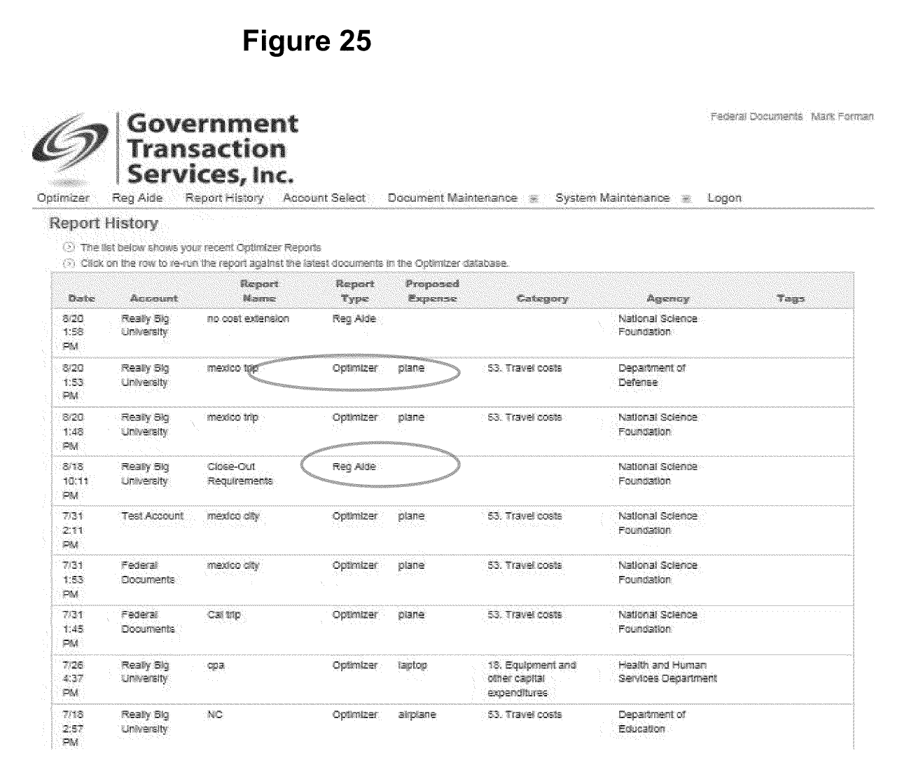

The invention includes a catalog of prior reports, which may be listed chronologically as displayed in the screenshot in FIG. 25. The listing may identify when a report was created, key elements of the report, and whether it was an allowable expenditure report (“Optimizer”) or regulation guidance report (“Reg aide”). The invention may enable the report to be displayed over an internet browser by selecting a report line.

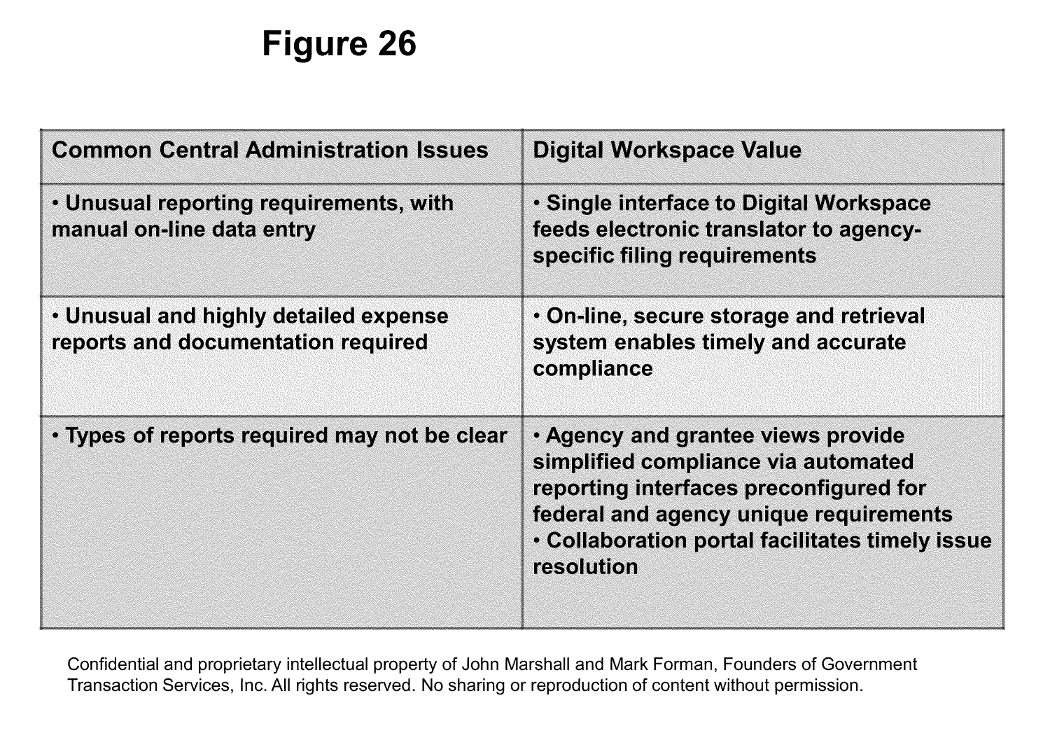

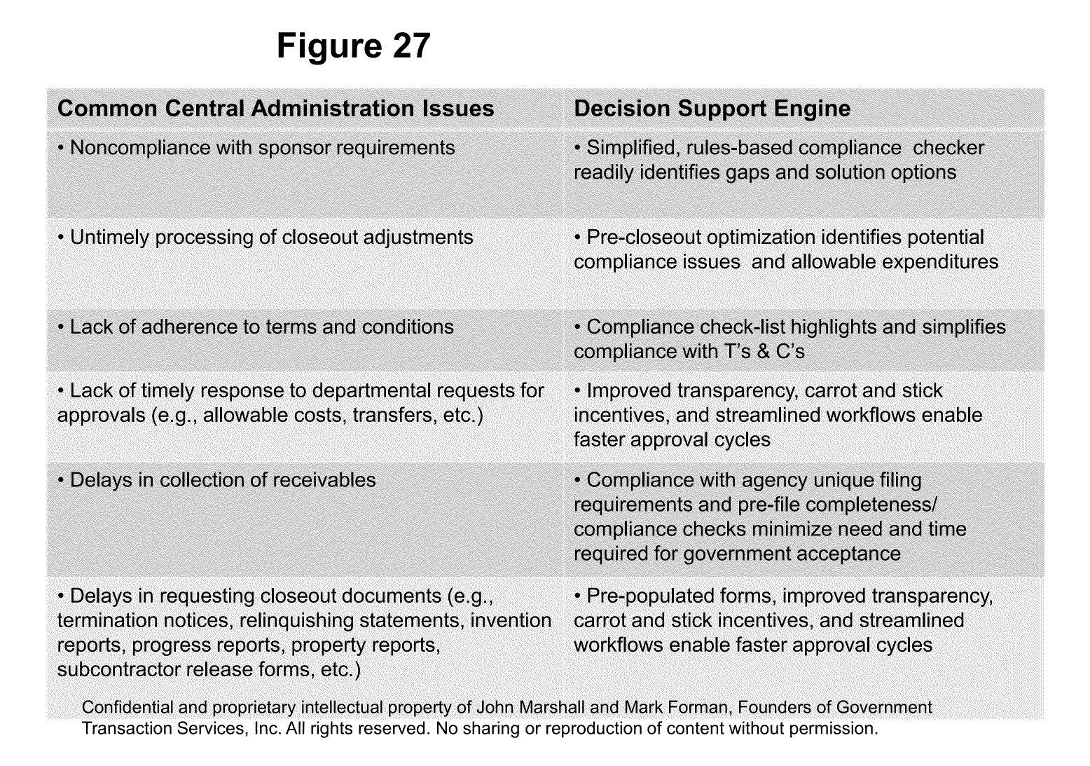

These are just examples of embodiments of systems and methods that use “cloud” technologies to standardize and simplify transactions between the Federal government and entities that do business with it. The invention will provide user institutions: improved compliance; easier document assembly and audit preparation; enhanced decision-making on allowable expenditures; risk management of regulatory compliance issues; easy-to-use interface that is highly intuitive and easy to learn; aggregating views for users with multiple grants, such as grant administrators; and secure access and controls assigned by user. FIG. 26 is a table listing the concerns of Grant Administrators from market research results and how the digital workspace of the invention resolves those concerns. FIG. 27 is a table listing the regulatory compliance concerns revealed in market research and details regarding how the decision support engine resolves those concerns. Together, these Tables document the value of the invention in addressing regulatory compliance and paperwork burden problems facing Federal grant recipients.

The invention may also be adapted to other Federal filings where agencies are not able to receive electronic computer-to-computer submissions but use their website and manual data entry, would be automated using commercially available robot forms and/or similar technologies to reduce filing burden and costs, and there exists multiple overlapping sets of regulatory guidance. Currently, there are over 6000 Federal forms which could be candidates for applying one or more components of the invention. In addition, the decision support engine may be applied within Federal agencies to assist in administrative or programmatic activities.

What is claimed is:

1. A system for facilitating administrative reporting pertaining to a grant, comprising:
cloud storage including data files for account user data, grant reporting documentation, grant audit preparation, and grant results/products; and secure storage and access for user account/e-commerce data, records management and archiving; and the system further comprising a grant decision support engine for optimizing use of grant funds, the grant decision support engine comprising:
an interface to allow a user to elect to see if there is a warning light for audit risk related to the magnitude of likely unused funds;
a processor for calculating a warning based on % remaining funds for last phase of grant and displaying a red flag and risk management language in a report if the percent magnitude of available funds exceeds the percent of time remaining in a grant during the last quarter of the grant.

2. The system of claim 1, further comprising a common language expenditure system for receiving user input of a common language expenditure and correlating the input to regulatory guidance and providing the user with the options of at least one of: evaluating possible expenditures and Federal controls over those expenditures; and receiving interactive guidance in managing risks of grant administration including issuance of a request for extension for the grant time period and other regulatory approvals.

3. The system of claim 1, further comprising a data conversion engine for converting and consolidating captured grant data into an XML object.

4. The system of claim 1, further comprising a grant audit preparation tool for linking digital images of receipts or other documents to reports to facilitate auditability.

5. The system of claim 1, further comprising data structures defining providing a hierarchical set of folders for records management on individual grants, such that for each grant, the digital workspace provides a pre-set folder template to organize and manage documents specific to the applicable auditing approach for obtaining documentation on a grant.

6. A method of optimizing use of grant funds through the use of a grant decision support engine, comprising:
receiving an election from a user indicating whether the user elects to see if there is a warning light for audit risk related to the magnitude of likely unused funds; if the user elects to see if there is a warning light for audit risk, calculating a warning based on % remaining funds for last phase of grant; and
displaying a red flag and risk management language on a report if the percent magnitude of available funds exceeds the percent of time remaining in a grant during the last quarter of the grant.

7. The method of claim 5, further comprising the steps of:
prompting the user to input a common language expenditure;
correlating the common language expenditure input by the user to regulatory guidance and providing the user with the options of at least one of:
evaluating possible expenditures and Federal controls over those expenditures; and
providing interactive guidance in managing risks of grant administration including issuance of a request for extension for the grant time period and other regulatory approvals.

8. The method of claim 7, wherein the method of providing interactive guidance in managing risks of acceptability of grant expenditures includes:
identifying recent government regulatory compliance and audit issues affecting the institution and asking questions regarding whether grant is experiencing a similar issue, whether controls to address the issue have been applied to the grant program and what portion of grant funds are effected;
identifying additional administrative requirements when the ratio of remaining funds to time exceed 1.0, increasing the likelihood of audit;
any new categories of spending or sub-grantees spending that were not included in the grant award; and
any new subcontractors or sub-grantees that were not included in the grant award.

9. The method of claim 6, further comprising the step of converting and consolidating captured grant data into a single XML object.

10. The method of claim 6, further comprising the step of linking digital images of receipts or other documents to reports to facilitate auditability.

11. The method of claim 6, further comprising the step of providing a hierarchical set of folders for records management on individual grants, such that for each grant, the digital workspace provides a pre-set folder template to organize and manage documents specific to the applicable auditing approach for obtaining documentation on a grant.

12. A method for using shared hardware, software and storage resources that communicate through a network to facilitate grant reporting comprising:
receiving information from a user;
organizing the information using a unique taxonomy and folder structure;
identifying a form to be completed;
using user submitted data and previously stored data to automatically generate a form with data input;
presenting the automatically generated form to the user for review and additional data input;
prompting user to review and provide missing information;
receiving additional data from the user;
using a compliance review engine to review the form for compliance and to identify gaps or suggestions and, based on the review, prompting the user for additional information or preparing the file for submission;
determining whether any agencies require an on-line manual data entry and, if so, using a robot to get data into the agencies that require an on-line manual data entry; and
filing with the government agency.
